(19) United States
(12) Patent Application Publication
(10) Pub. No.: US 2026/0204822 A1
(43) Pub. Date: Jul. 16, 2026

(54) SYSTEM WITH INTERMEDIATE CONNECTOR, AND FPC BOARD USED THEREFOR

(71) Applicant: Hirose Electric Co., Ltd., Yokohama (JP)

(72) Inventors: Nobuhiro TAMAI, Yokohama (JP); Chunkai Yang, Yokohama (JP); Shaolong Wu, Yokohama (JP)

(21) Appl. No.: 19/446,323

(22) Filed: Jan. 12, 2026

(30) Foreign Application Priority Data
Jan. 14, 2025 (JP) 2025-004532

(51) Int. Cl. H01R 12/79; H01R 12/73

(52) U.S. Cl. CPC H01R 12/79; H01R 12/737

(57) ABSTRACT

To provide an intermediate connector offering improvements in overcoming signal degradation, delays and other problems between a first board and a second board, as well as an FPC board used therefor, there is a system provided with an intermediate connector, the intermediate connector comprising a housing having a first housing portion and a second housing portion, in which a first insertion space, into which a first board is inserted, is provided in the first housing portion, and a second insertion space, into which a second board is inserted, is provided in the second housing portion; and a plurality of terminals installed so as to span both the first housing portion and the second housing portion; the system being attachable such that at least a portion of the second housing portion is inserted into a through-hole provided in a system board that forms part of the system.

### CROSS-REFERENCE TO RELATED APPLICATIONS

This application claims priority to Japanese Patent Application No. 2025-004532, filed January 14, 2025, the contents of which are incorporated herein by reference in its entirety for all purposes.

### TECHNICAL FIELD

The present invention relates to a system having an intermediate connector, more specifically, a system having an intermediate connector capable of connecting a first board and a second board, and an FPC board used therefor.

### BACKGROUND ART

Optical transceivers, i.e., devices for converting optical signals into electrical signals and vice versa, are electrically connected to application-specific integrated circuits (ASICs) mounted on printed wiring boards through the medium of receptacle connectors mounted on the printed wiring boards.

It is common for a conventional receptacle connector to be mounted on a printed board such that the direction of insertion and extraction of the optical transceiver is parallel to the surface

of the printed board (e.g., see Patent Document 1). However, since under such a mounting method the distance from the receptacle to the integrated circuit, in other words, the pattern length of the printed board increases depending on the location where the optical transceiver is disposed, signal degradation, delays and other problems arise as the speed of signal transmission increases.

In the invention described in Patent Document 2, the above problem is addressed by making the direction of insertion and extraction of the optical transceiver perpendicular to the surface of the printed board. In Patent Document 2, a receptacle assembly 30, which electrically connects a pluggable module 20 or another optical transceiver to an integrated circuit 13 or another application-specific integrated circuit (ASIC), is mounted substantially perpendicular to the front face 101 of a printed board (wiring board) 100 provided in the casing 11 of a communication system 10. The receptacle assembly 30 has a connector 200 and a cage 400 accommodating said connector 200, and, upon insertion of the module 20 into the connector 200, the module 20, while being disposed substantially perpendicular to the surface of the printed board, is electrically connected to the front face 101 of the printed board 100 and transmits signals across the printed board 100 through the medium of patterns applied to the printed board 100. As can be seen, if the configuration of Patent Document 2 is used, the pattern length of the printed board can be shortened compared to when the direction of insertion and extraction of the optical transceiver is parallel to the surface of the printed board, as in the case of the connector of Patent Document 1, and accordingly, signal degradation, delays and other problems can be alleviated to a certain degree. However, even in the invention described in Patent Document 2, the above-mentioned problems are not completely resolved because all communications are carried out through the medium of patterns on the printed board.

### Patent Documents

Patent Document 1 Japanese Patent No. 7082068.

Patent Document 2 U.S. Patent Publication No. 2004/0097374.

### SUMMARY

### Problems to be Solved

It is an object to provide a system having an intermediate connector that addresses the above-described prior-art problems, and an FPC board used therefor.

### Technical Solution

To eliminate the above problems, a system provided with an intermediate connector according to an implementation of the present invention is characterized in that the intermediate connector comprises a housing having a first housing portion and a second housing portion, in which a first insertion space, into which a first board is inserted, is provided in the first housing portion, and a second insertion space, into which a second board is inserted, is provided in the second housing portion; and a plurality of terminals installed so as to span both the first housing portion and the second housing portion; the system being attachable such that at least a portion of the second housing portion is inserted into a through-hole provided in a system board that forms part of the system.

Due to the fact that this implementation of the system makes it possible to attach an intermediate connector such that at least a portion of the second housing portion is inserted into a through-hole provided in a system board that forms part of the system, the first and second boards can be connected directly through terminals provided in the interior of the intermediate connector, without the use of the patterns on the printed board.

### Technical Effect

Provided are a system that offers improvements in overcoming signal degradation, delays and other problems between a first board and a second board due to the fact that the first and second boards can be connected directly through terminals without the use of patterns on the printed board, and an FPC board used therefor.

### BRIEF DESCRIPTION OF THE DRAWINGS

FIG. 1 is a perspective view showing an intermediate connector according to an embodiment of the present invention along with boards that can be used with the intermediate connector and peripheral components thereof, illustrating a state prior to connection of the boards.

FIG. 2 is a perspective view showing an intermediate connector according to an embodiment of the present invention along with boards that can be used with the intermediate connector and peripheral components thereof, illustrating a state subsequent to connection of the boards.

FIG. 3 is a schematic perspective view showing an aspect of use of a system according to an embodiment of the present invention provided with the intermediate connector shown in FIGS. 1, 2.

FIG. 4 is a perspective view of a single FPC board that can be used in an intermediate connector according to an embodiment of the present invention.

FIG. 5 is a perspective view illustrating an FPC board inside an intermediate connector upon connection of the FPC board to the intermediate connector.

FIG. 6 is a perspective view illustrating the FPC board inside the intermediate connector upon further connection of a card-edge board to the intermediate connector.

FIG. 7 is an enlarged view of the multiple terminals and mounting brackets provided in the intermediate connector shown in FIGS. 5 and 6.

FIG. 8 is a perspective view of signal terminals and ground terminals.

FIG. 9 is a perspective view of signal-type terminals and power-type terminals.

FIG. 10 is a partial enlarged view of a board face of a system board.

FIG. 11 is a perspective view of a mounting bracket.

FIG. 12 is a perspective front face view of an intermediate connector in a horizontally mounted configuration.

FIG. 13 is a perspective rear face view of an intermediate connector in a perpendicularly mounted configuration.

FIGS. 14(a) to 14(c) illustrate a front face view, a plan view, and a rear face view of an intermediate connector.

FIG. 15 is a perspective view showing an intermediate connector attached to a system board in the same manner as in FIG. 13.

FIG. 16 is a plan view of FIG. 15.

FIG. 17 is a cross-sectional view along line A–A in FIG. 16, showing a cross-section taken through a signal terminal included in the first terminal group A.

FIG. 18 is a cross-sectional view along line B–B in FIG. 16, showing a cross-section taken through a signal terminal included in the second terminal group B.

FIG. 19 is a cross-sectional view along line C–C in FIG. 16, showing a cross-section taken through a ground terminal included in the first terminal group A.

FIG. 20 is a cross-sectional view along line D–D in FIG. 16, showing a cross-section taken through a ground terminal included in the second terminal group B.

FIG. 21 is a cross-sectional view along line E–E in FIG. 16, showing a cross-section taken through a power-type terminal included in the first terminal group A.

FIG. 22 is a cross-sectional view along line F–F in FIG. 16, showing a cross-section taken through a power-type terminal included in the second terminal group B.

### DETAILED DESCRIPTION

An exemplary embodiment of the present invention is described below with reference to the accompanying drawings. While only the preferred embodiment is shown here for ease of explanation, it is of course not intended that the present invention be limited thereto.

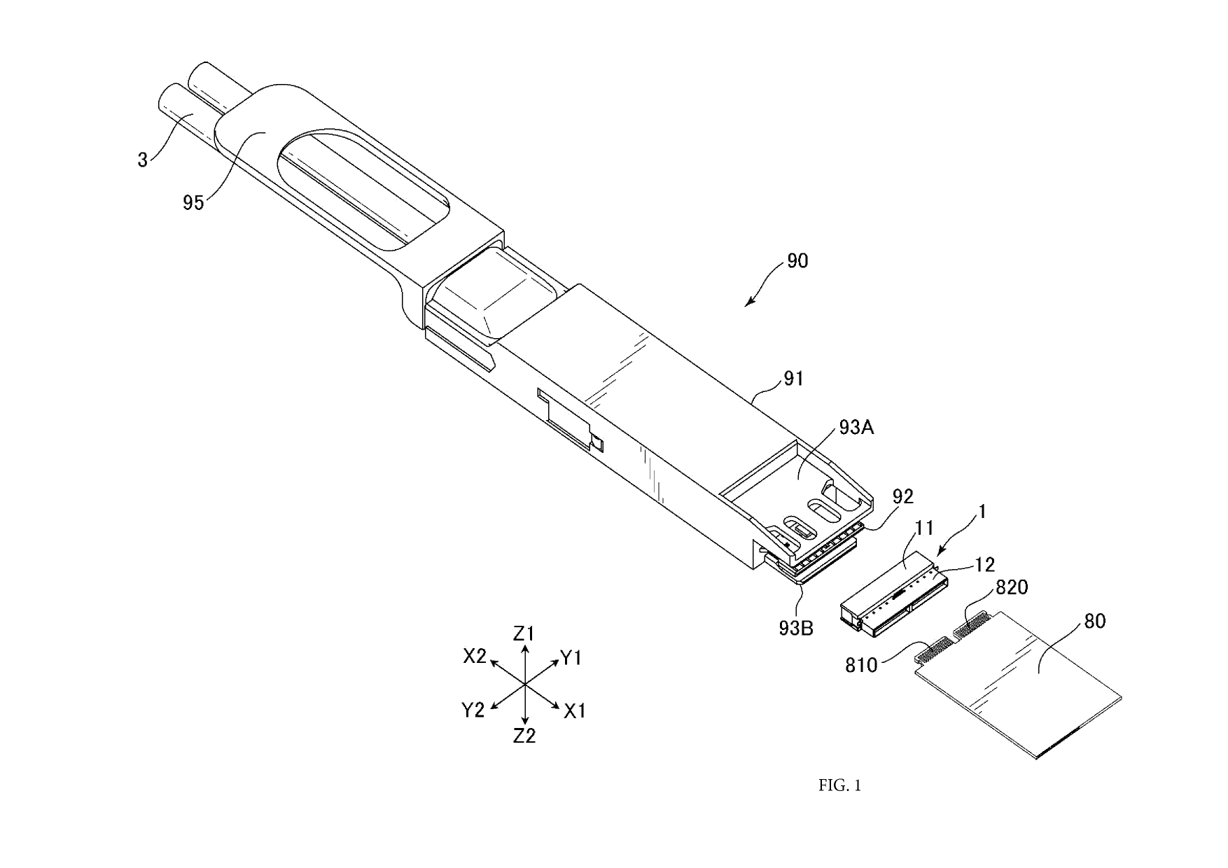

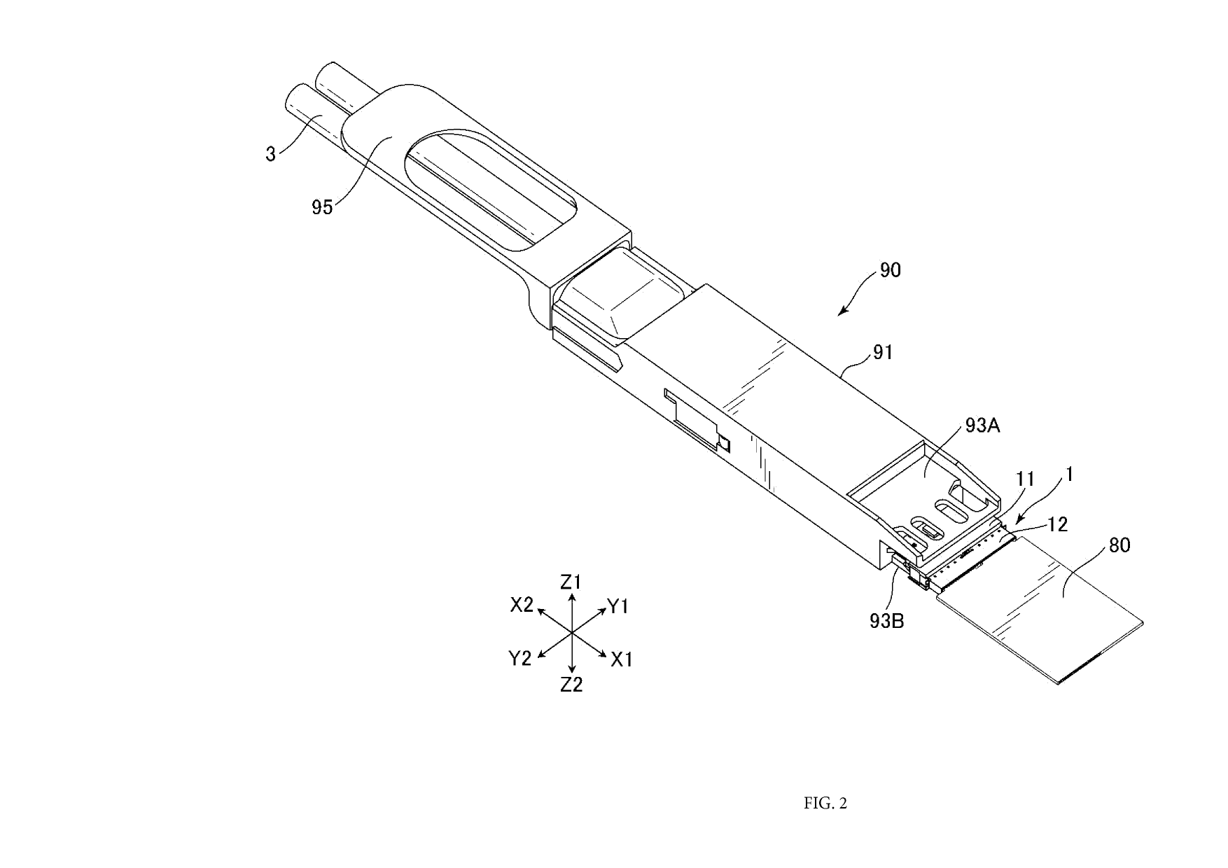

An intermediate connector that can be used in a system according to an embodiment of the present invention, along with boards that can be used with the intermediate connector, and peripheral components thereof, is shown in perspective in FIGS. 1, 2. Using this intermediate connector 1 makes it possible, for example, to interconnect a card-edge board 92 (“first board”) and an FPC board 80 (“second board”), which are inserted respectively into a first housing portion 11 and a second housing portion 12 in the intermediate connector 1. It should be noted that the card-edge board 92 and the FPC board 80 are merely examples of the boards that can be interconnected by the intermediate connector 1, and the present embodiment is not limited to the use of these boards. A state prior to connection of these boards and a state subsequent to connection thereof are respectively illustrated in FIG. 1 and FIG. 2.

The card-edge board 92 can be a publicly known device, and a commercial product such as the one shown in FIGS. 1, 2 should suffice. For example, it can be a component part of a module such as an optical transceiver 90. It should be noted that the optical transceiver 90 is an example of a module that can be used with the card-edge board 92, and the card-edge board 92 can be provided in a different module other than an optical transceiver 90 and can also be used as a card-edge board 92 alone without using a module.

The card-edge board 92 illustrated in FIGS. 1, 2, which is provided in the front end portion of the main body 91 of the optical transceiver 90 while being sandwiched between internal boards 93A, 93B in the up-down direction “Z” (“third direction”), which is orthogonal to both the forward-backward direction “X” (“first direction”) and the width direction “Y” (“second direction”), i.e., incorporated into the optical transceiver 90, has a predetermined length in the width direction “Y”, which is orthogonal to the forward-backward direction “X”. A cable support portion 95, which can support an optical cable 3 in the forward-backward direction “X”, is provided at the rear end.

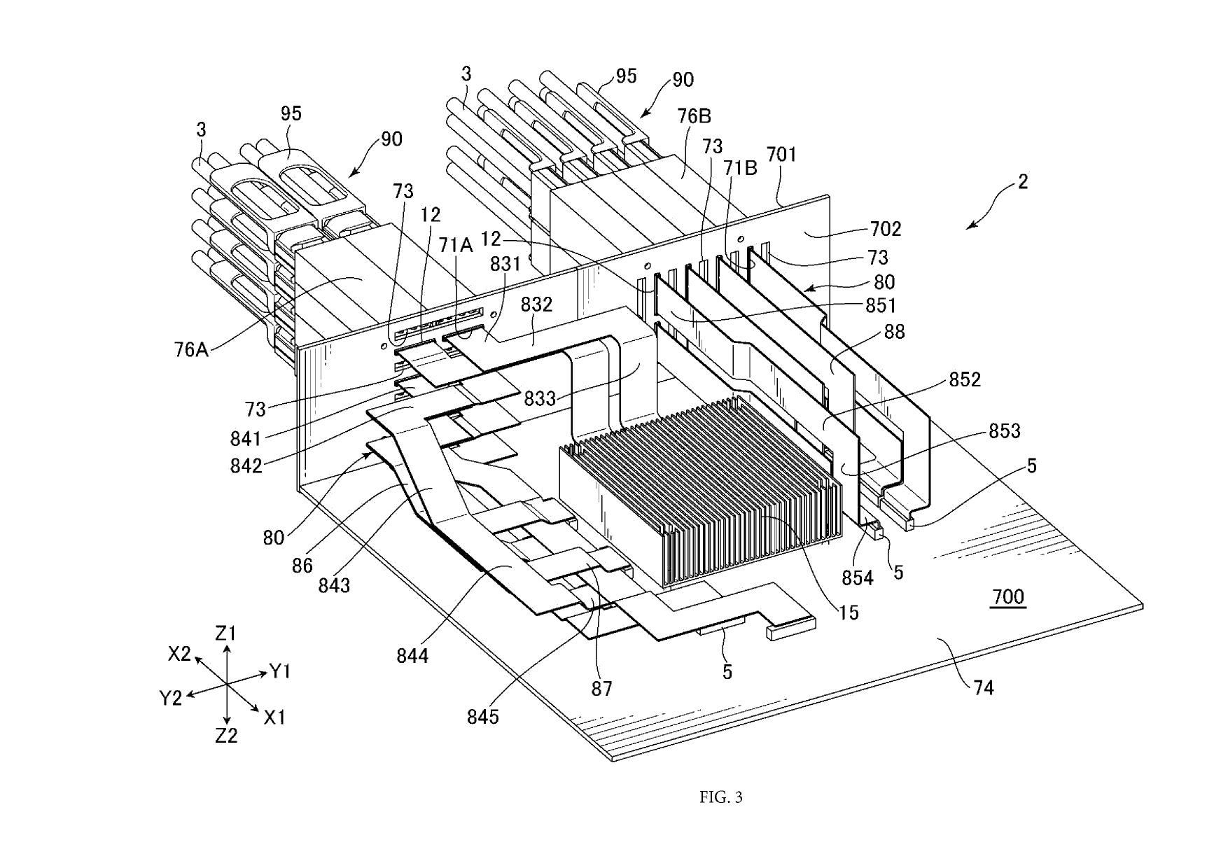

An aspect of use of the system according to the present embodiment, in which the intermediate connector shown in FIGS. 1, 2 is provided, is illustrated in a schematic perspective view in FIG. 3. This system 2 includes a casing (70, 74) and, attached to the casing, multiple enclosures 76 and multiple intermediate connectors 1 (only the second housing portion 12 is visible in FIG. 3).

With regard to the casing, for convenience, only some component parts that make up the casing, namely, the system board 70, which forms a side wall, and the base plate 74, which forms a bottom wall, are illustrated in FIG. 3. The system boards 70A, 70B are disposed adjacent each other in the width direction “Y”, and both of them form one side wall of the casing. In addition, although a variety of component parts are actually accommodated in the interior 700 of the casing, only the FPC boards 80 and some component parts associated with the present embodiment, i.e., connectors 5 and a heat sink 15, are illustrated in order to simplify the drawing. It should be noted that in the following description and drawings, the letters “A” or “B” are added to reference numerals only when making a distinction is believed to be advantageous.

The enclosures 76 are provided in an outwardly upright configuration perpendicular to one board face 701 of the system board 70. The orientation, in which the enclosures 76 are attached to the system board 70, is not particularly limited, such that, for example, the enclosures 76A provided in the system board 70A are attached in a horizontal orientation “Y”, and the enclosures 76B provided in the system board 70B are attached in a perpendicular orientation “Z”. An optical transceiver 90, provided with a card-edge board 92 such as the one illustrated in FIGS. 1, 2, is inserted into each enclosure 76 in the direction from one board face 701 toward the other board face 702 (X1). In other words, as in the case of the invention described in Patent Document 2, the system board 70 of the present embodiment is provided perpendicularly to the direction of insertion and extraction of the optical transceivers 90, in a plane (Y–Z plane) formed by the width direction “Y” and the up-down direction “Z”. Upon insertion of an optical transceiver 90 into an enclosure 76, the card-edge board 92 provided at the distal end of the optical transceiver 90 is inserted into the first housing portion 11 of the intermediate connector 1.

Each intermediate connector 1 is attached to the casing such that a portion of the second housing portion 12 is inserted into a through-hole 71 provided in the system board 70 in the direction from one board face 701 toward the other board face 702 (X1) (only the inserted second housing portion 12 is visible in FIG. 3). The through-holes 71 are provided through the space between the board faces 701, 702, which form planes orthogonal to the direction of insertion “X1” of the second housing portion 12, in other words, planes (Y–Z planes) formed by the width direction “Y” and the up-down direction “Z”. Furthermore, vents 73, which are placed in communication with the interior 700 of the casing, are provided in the system board 70 to cool the interior 700 of the casing. The vents 73 are disposed between every two through-holes 71, thereby allowing for heat emitted by the FPC boards 80 to be efficiently discharged to the exterior of the casing.

At one end thereof, an FPC board 80 is inserted into the second housing portion 12 of each intermediate connector 1 in the direction from the other board face 702 toward the one board face 701 (X2). At such time, the FPC board 80 is accommodated in the interior 700 of the casing. Despite the fact that the FPC boards 80 used in the present embodiment have a somewhat unusual shape, the basic construction thereof is identical to that of ordinary FPC boards. Accordingly, the FPC boards 80 can be readily fabricated by adapting commercial products. In addition to rectilinear sections 831, 841, 851, which have one end thereof inserted into a second housing portion 12, the FPC boards 80 further include extension sections 832–833, 842–845, and 852–854, which extend in the width direction “Y” and/or in the downward direction “Z2” toward the base plate 74. The other end of the FPC boards include the ends of the extension sections 832–833, which are connected to the connectors 5 provided on the base plate 74, and the ends of the extension sections 842–845, 852–854, which are connected to the heat sink 15 provided on the base plate 74. Gaps 86–88, which are made as large as possible while achieving the shortest distance in the direction toward the connectors 5, are formed between every two extension sections 832–833, 842–845, and 852–854 in order to enhance the cooling effect.

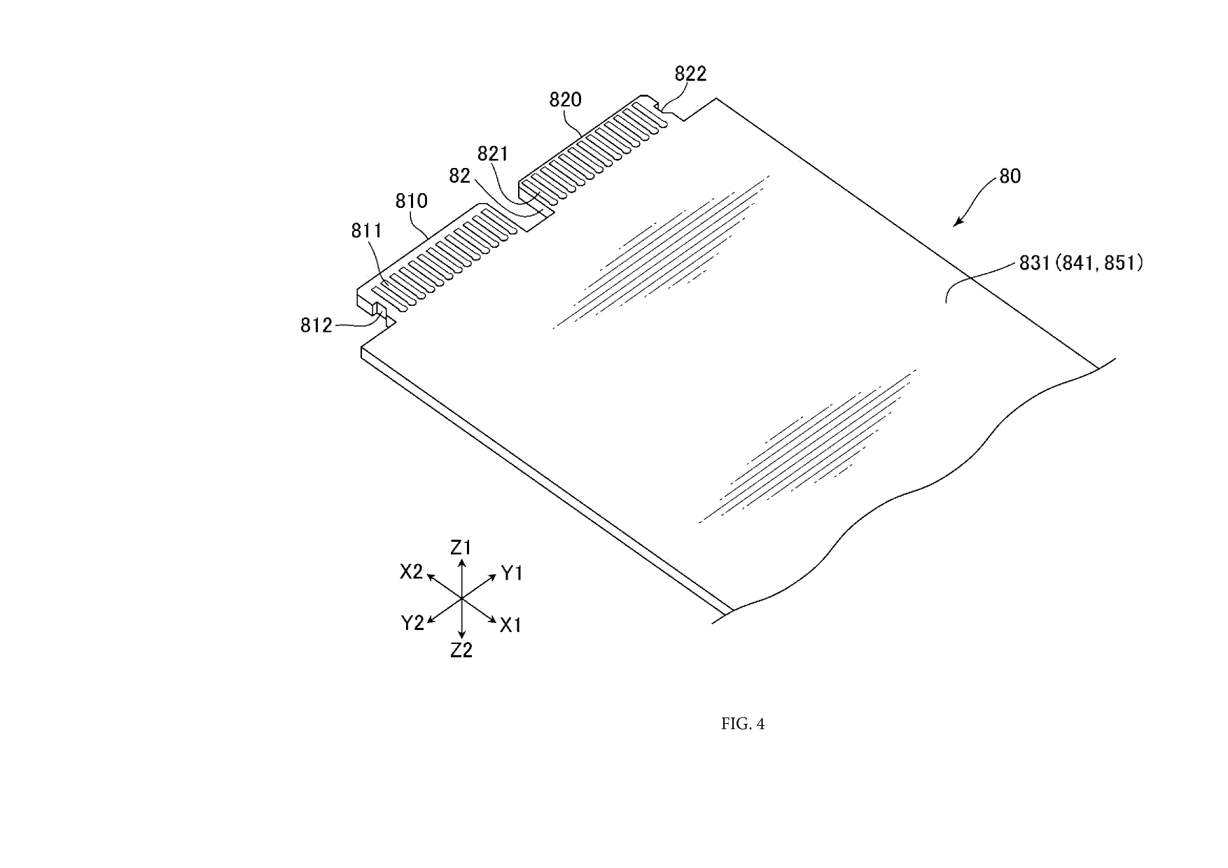

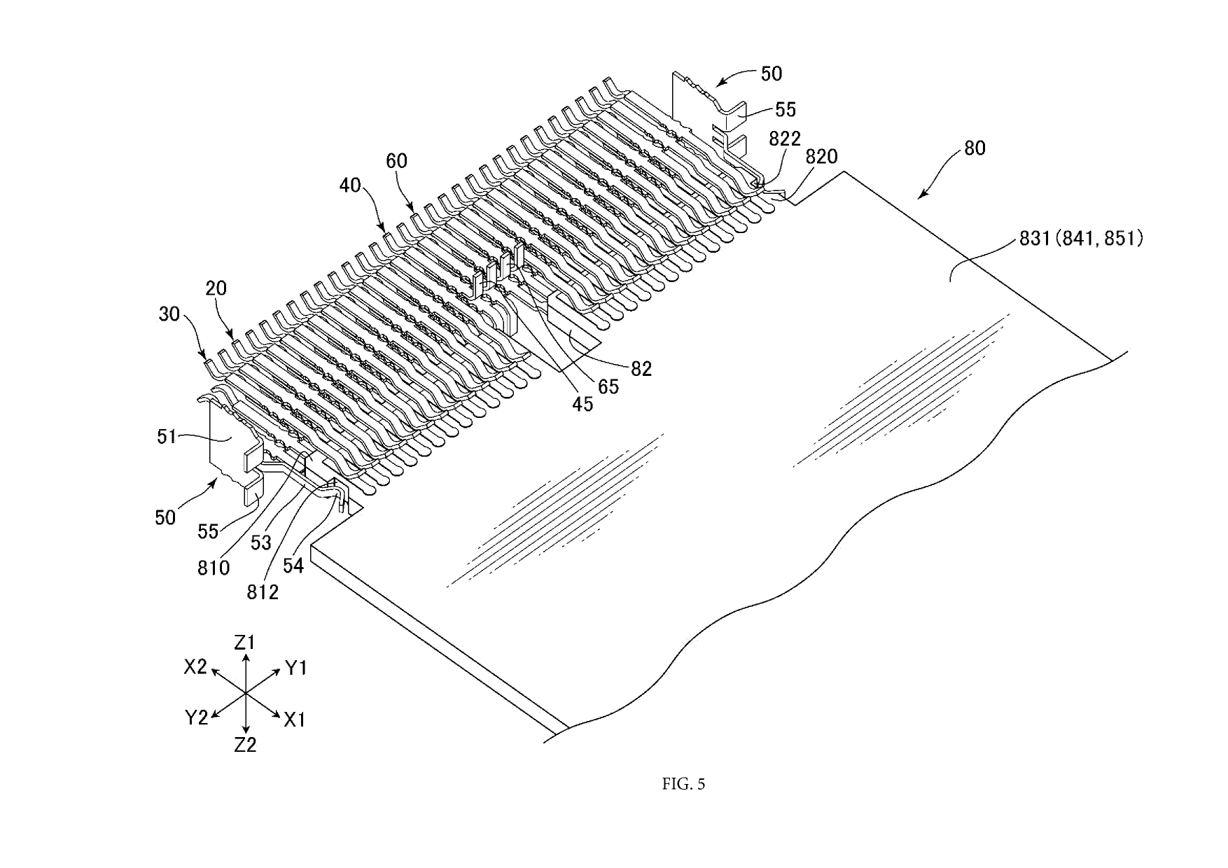

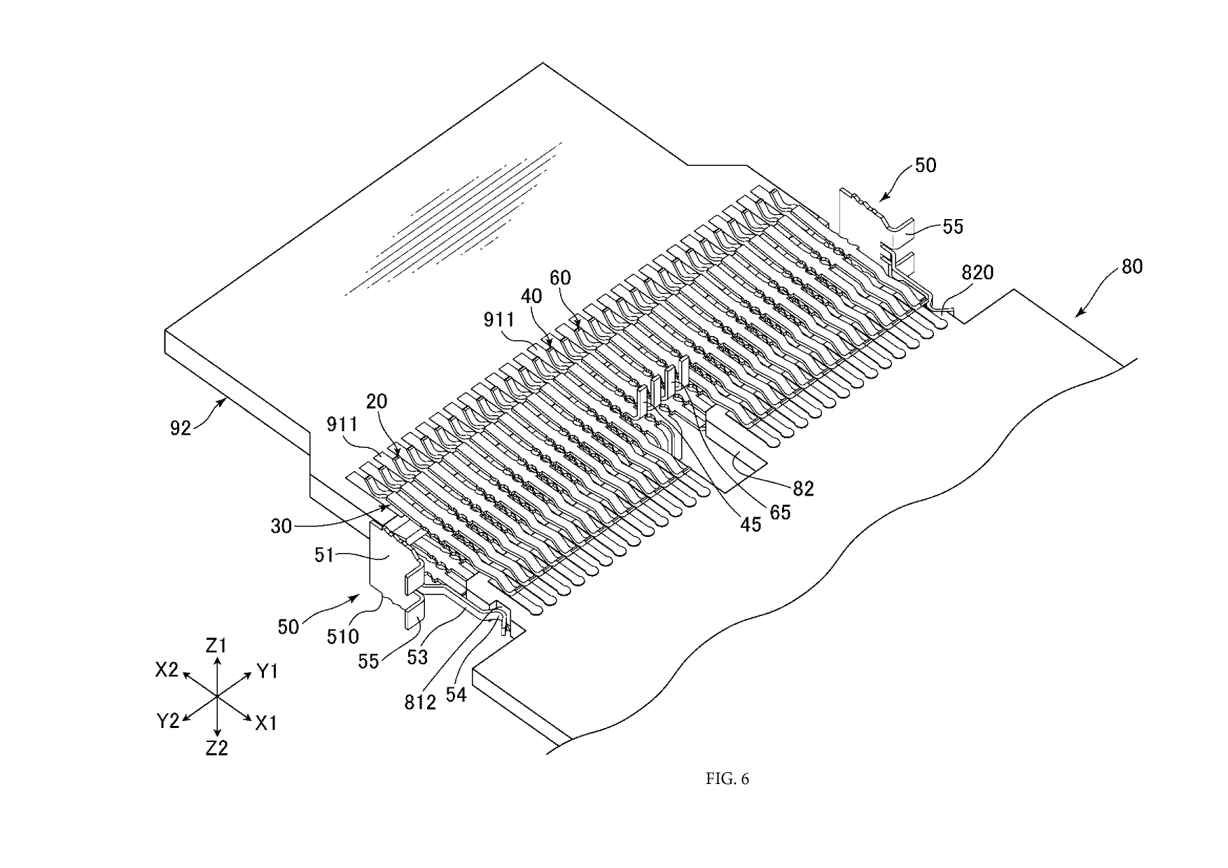

A detailed structure of one end of an FPC board is shown in perspective view in FIGS. 4 to 6. FIG. 4 is a perspective view of a single FPC board at this one end, FIG. 5 is a perspective view illustrating the FPC board inside an intermediate connector upon connection of the FPC board to the intermediate connector, more specifically, a state of connection between the FPC board and the multiple terminals and mounting brackets provided in the intermediate connector, and FIG. 6 is a perspective view illustrating the FPC board inside the intermediate connector upon further connection of a card-edge board to the intermediate connector, more specifically, a state of connection between the FPC board, the card-edge board, and the multiple terminals and mounting brackets provided in the intermediate connector.

As clearly shown in FIG. 4, the FPC board 80 has a first pad portion 810 and a second pad portion 820, which are disposed at one end in the forward-backward direction “X” adjacent each other in the width direction “Y”, with a gap 82 therebetween. Multiple first pads 811 and second pads 821 arranged side by side in the width direction “Y” are provided on both the front and back of the first pad portion 810 and second pad portion 820 in alignment with the multiple terminals 20, 30 provided in the intermediate connector 1. In addition, engageable recessed portions 812, 822 used to lockingly engage the FPC board 80 with the intermediate connector 1 are provided in the exterior side faces of the first pad portion 810 and second pad portion 820 in the width direction “Y” thereof.

As shown in FIG. 5, when the FPC board 80 is connected to the intermediate connector 1, the multiple terminals 20, 30 provided in the intermediate connector 1 are each resiliently connected to the first pads 811 and second pads 821, respectively, while the locking engagement portions 54 of the mounting brackets 50 provided in the intermediate connector 1 are resiliently engaged with the engageable portions 812, 822 respectively provided in the first pad portion 810 and second pad portion 820. In the same manner, as shown in FIG. 6, when the card-edge board 92 is connected to the intermediate connector 1, multiple terminals 20, 30 provided in the intermediate connector 1 are each resiliently connected to multiple pads 911 provided on the card-edge board 92 and, furthermore, in addition to these terminals 20, 30, terminals 40, 60 are also resiliently connected in the same manner.

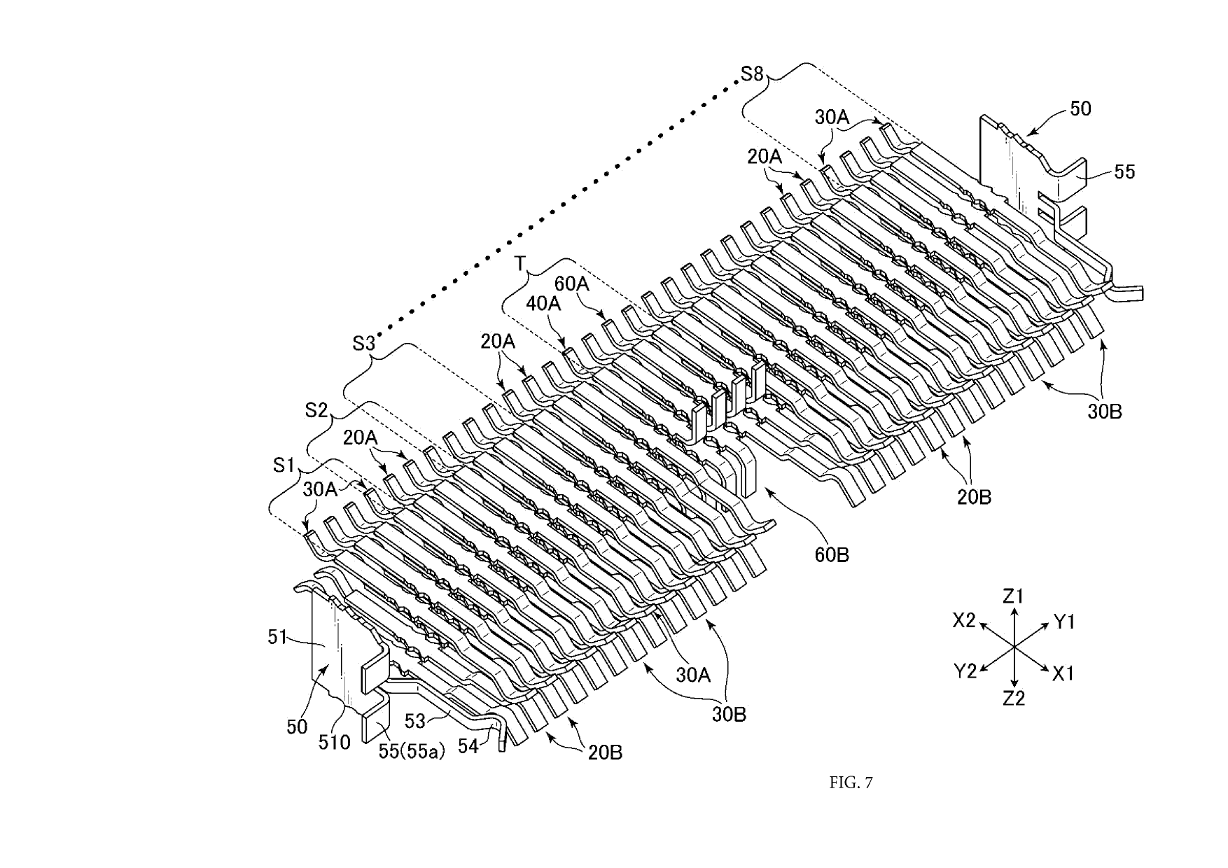

FIG. 7 shows an enlarged view of the multiple terminals 20, 30, 40, 60 and mounting brackets 50 shown in FIGS. 5 and 6. These terminals 20, 30, 40, 60 can be classified into two groups in the up-down direction “Z”, thereby forming a first terminal group A including one portion of the respective terminals 20, 30, 40, 60 at the top, and a second terminal group B including the other portion of the respective terminals 20, 30, 40, 60 at the bottom. The first terminal group A and second terminal group B are provided in a mutually spaced-apart relationship in the up-down direction “Z” and, in addition, several terminals 20A, 30A, 40A, 60A included in the first terminal group A and the other several terminals 20B, 30B, 40B, 60B included in the second terminal group B have the same arrangement in the width direction “Y” and are offset with respect to each other and disposed in a staggered configuration in the width direction “Y”. Due to the fact that the several terminals 20A, 30A, 40A, 60A included in the first terminal group A and the other several terminals 20B, 30B, 40B, 60B included in the second terminal group B have the same arrangement in the width direction “Y”, a detailed description is provided below only for the first terminal group A, and the description of the second terminal group is omitted or simplified.

The first terminal group A includes signal terminals 20A, ground terminals 30A, and board connection terminals 40A, 60A. The board connection terminals 40A, 60A further include signal-type terminals 40A and power-type terminals 60A. All these signal terminals 20A, ground terminals 30A, signal-type terminals 40A, and power-type terminals 60A are installed in the forward-backward direction “X” and arranged side by side equidistantly from one another in a mutually adjacent relationship in the width direction “Y”. In the same manner, in the intermediate connector 1, all the signal terminals 20B, ground terminals 30B, signal-type terminals 40B, and power-type terminals 60B included in the second terminal group B are also installed in the forward-backward direction “X” and arranged side by side equidistantly from one another in a mutually adjacent relationship in the width direction “Y”.

The first terminal group A and second terminal group B form a gap in the up-down direction “Z” for sandwiching the first pad portion 810 and second pad portion 820 of the FPC board 80 at the front in the forward-backward direction “X”, and, in the same manner, form a gap in the up-down direction “Z” for sandwiching the pad portions of the card-edge board 92 at the back in the forward-backward direction “X”. When the FPC board 80 and the card-edge board 92 are connected to the intermediate connector 1, the FPC board 80 is inserted into the gap formed at the front while the card-edge board 92 is inserted into the gap formed at the back in the forward-backward direction “X”, thereby causing them to abut against each other in the forward-backward direction “X” from opposite sides in the forward-backward direction “X”.

The signal terminals 20A and ground terminals 30A included in the first terminal group A are arranged side by side such that a sequence of “ground terminal, signal terminal, signal terminal, ground terminal” makes up a single set “S”. In each set “S”, two signal terminals 20A are sandwiched by two ground terminals 30A on both sides. Using such a side-by-side arrangement makes it possible to alleviate the problem of so-called crosstalk. In the first terminal group A, in the width direction “Y”, there are provided a total of eight such sets “S”, that is, sets “S1” to “S8”. More specifically, another set “T”, which is described below, is provided sandwiched between four sets “S1” to “S4” and another four sets “S5” to “S8”, i.e., in the middle in the width direction “Y”. It should be noted that the ground terminals forming the ends of each set “S” allow for overlapping with adjacent sets. For example, in the sets “S1” to “S3,” the signal terminals 20A and ground terminals 30A are arranged side by side in the sequence of “ground terminal 30A, signal terminal 20A, signal terminal 20A, ground terminal 30A, signal terminal 20A, signal terminal 20A, ground terminal 30A, signal terminal 20A, signal terminal 20A, ...,” with the fourth ground terminal 30A being a constituent element of both the first set “S1” and the second set “S2” and, in addition, the seventh ground terminal 30A being a constituent element of both the second set “S2” and the third set “S3”.

Another set, “T”, which is provided in the middle in the width direction “Y”, comprises signal-type terminals 40 and power-type terminals 60 included in the first terminal group A arranged side by side in the sequence of “signal-type terminal, power-type terminal, power-type terminal, signal-type terminal.” The set “T” is distinct from the above-described sets “S1” to “S8” and, accordingly, does not overlap with the terminals of the “S” sets.

FIG. 8 shows a perspective view of signal terminals 20 and ground terminals 30 in a configuration where the above-described set “S” is used as a unit, in other words, in a side-by-side arrangement in the sequence of “ground terminal, signal terminal, signal terminal, ground terminal.” The signal terminals 20 and ground terminals 30 have the same size and shape, and are each formed in a plate-like configuration by cutting and bending a metal sheet.

The signal terminals 20 are used for high-speed transmission. The signal terminals 20 have a base portion 21 in the middle and are provided with a first signal contact 23 at one end and a second signal contact 24 at the other end. In the state shown in FIG. 7, the first signal contacts 23 make contact with the predetermined pads of the card-edge board 92, and the second signal contacts 24 make contact with the predetermined pads of the FPC board 80, thereby connecting them. Press-fit projections 210 used for securing to the intermediate connector 1 are provided protruding in the width direction “Y” substantially in the middle of the base portion 21 and, furthermore, a stepped portion 25 used for adjusting the height of the first signal contact 23 and second signal contact 24 in the up-down direction “Z” is provided closer to the second signal contact 24 than the press-fit projections 210.

The ground terminals 30 are used for ground connections. As in the case of the signal terminals 20, the ground terminals 30 also have a base portion 31 in the middle and are provided with a first ground contact 33 at one end and a second ground contact 34 at the other end. In the state shown in FIG. 7, the first ground contacts 33 make contact with the predetermined pads of the card-edge board 92, and the second ground contacts 34 make contact with the predetermined pads of the FPC board 80, thereby connecting them to ground. As in the case of the signal terminals 20, there are press-fit projections 310 located substantially in the middle of the base portion 31 and, in addition, a stepped portion 35 is provided closer to the second ground contact 34.

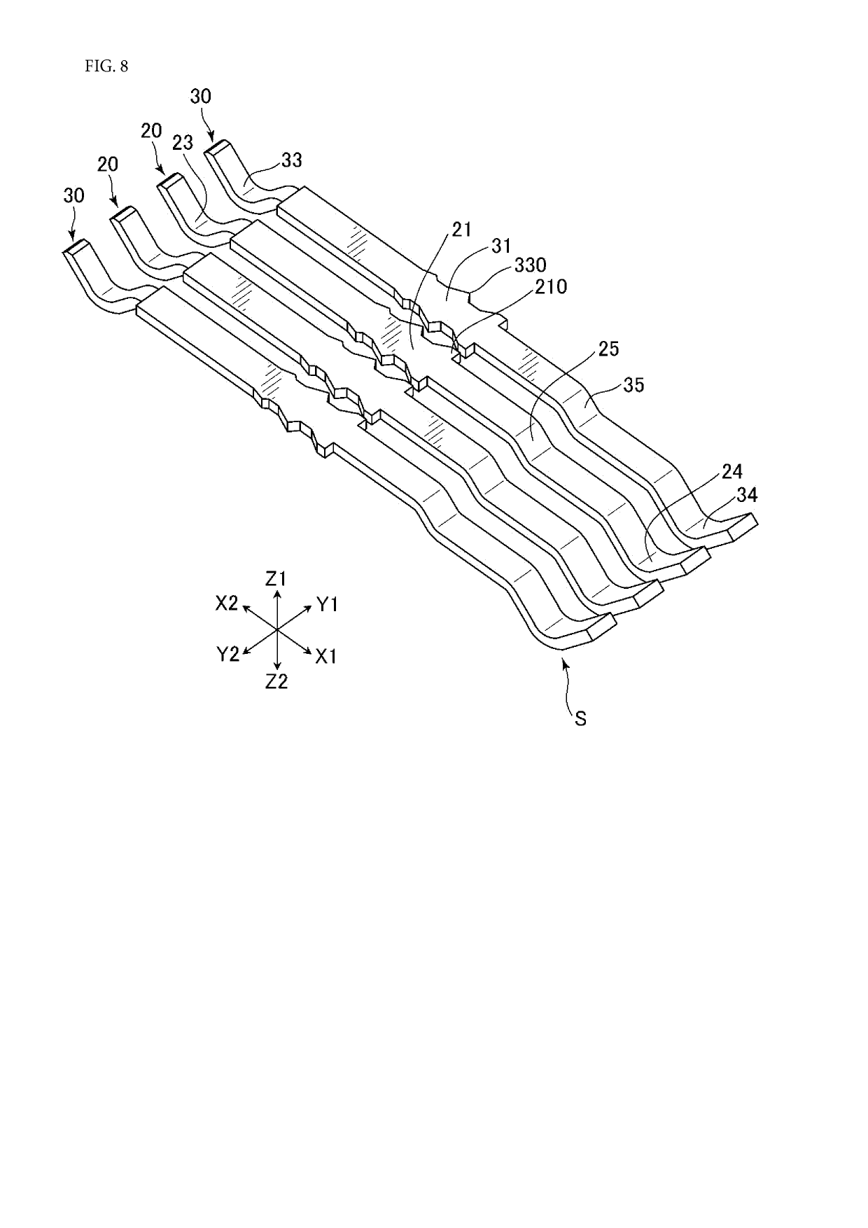

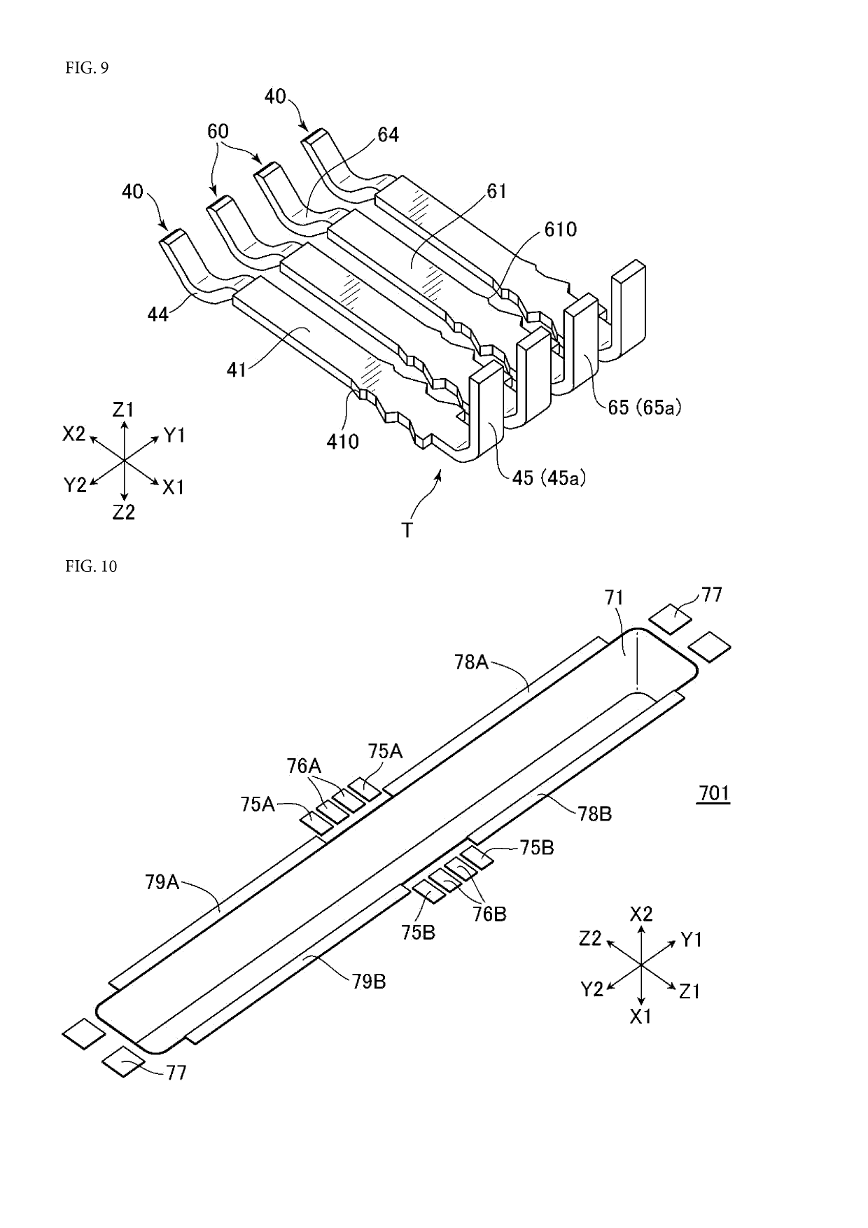

FIG. 9 shows a perspective view of the signal-type terminals 40 and power-type terminals 60 in a configuration wherein the above-described set “T” is used as a unit, in other words, in a side-by-side arrangement in the sequence of “signal-type terminal, power-type terminal, power-type terminal, signal-type terminal,” and FIG. 10 shows a partial enlarged view of the board face 701 of the system board 70 (see FIG. 3).

Multiple pads 75 to 79 are provided surrounding the periphery of a through-hole 71 on the board face 701 of the system board 70. As far as the pads 75, 76 are concerned, in each outer region of the through-hole 71 in the up-down direction “Z” and in the middle in the width direction “Y”, there are four pads disposed in the sequence of 75, 76, 76, 75 in the width direction “Y”. The signal-type terminals 40 and power-type terminals 60 are respectively soldered to these pads 75, 76. In addition, two pads 77 are provided in each outer region of the through-hole 71 in the width direction “Y”, for a total of four pads. The mounting brackets 50 are soldered to these pads 77. Furthermore, in each outer region of the through-hole 71 in the up-down direction “Z”, strip-shaped common pads 78, 79 extending along the edges of the through-hole 71 in the width direction “Y” are provided in a spaced-apart relationship in the width direction “Y”, with the pads 75, 76 located therebetween. The ground terminals 30 are soldered to these common pads 78, 79.

As in the case of the signal terminals 20 and ground terminals 30, the signal-type terminals 40 and power-type terminals 60 have the same size and shape, and are each formed in a plate-like configuration by cutting and bending a metal sheet. Although the signal-type terminals 40 and power-type terminals 60 extend in the forward-backward direction “X” as a whole, unlike the signal terminals 20 and ground terminals 30, their ends on one side are bent at right angles so as to stand perpendicular to the housing 10, in this case, in the up-down direction “Z”.

The signal-type terminals 40 are used for low-speed transmission. The signal-type terminals 40 have a base portion 41 in the middle and, at one end, a signal-type contact 44, i.e. an electrical contact, and, at the other end, a board connection portion 45 in which, by bending at right angles in the up-down direction “Z”, a connection face 45a is provided in a plane (Y–Z plane) formed by the width direction “Y” and the up-down direction “Z”. In the state shown in FIG. 7, the electrical contacts 44 make contact with the predetermined pads of the card-edge board 92, and the board connection portions 45 are soldered to the pads 75 of the system board 70, thereby connecting the card-edge board 92 to the system board 70. Press-fit projections 410 used for securing to the intermediate connector 1 are provided protruding in the width direction “Y” in the area of the base portion 41 proximate to the board connection portion 45.

The power-type terminals 60 are used for supplying power to the optical transceivers 90 through the system board 70. As in the case of the signal-type terminals 40, the power-type terminals 60 also have a base portion 61 in the middle and, at one end, a power-type contact 64, i.e. an electrical contact, and, at the other end, a board connection portion 65 in which, by bending at right angles in the up-down direction “Z”, a connection face 65a is formed in a plane (Y–Z plane) formed by the width direction “Y” and the up-down direction “Z”. In the state shown in FIG. 7, the electrical contacts 64 make contact with the predetermined pads of the card-edge board 92, and the board connection portions 65 are soldered to the pads 76 of the system board 70, thereby connecting the card-edge board 92 to the system board 70. Press-fit projections 610 used for securing to the intermediate connector 1 are provided protruding in the width direction “Y” in the area of the base portion 61 proximate to the board connection portion 65.

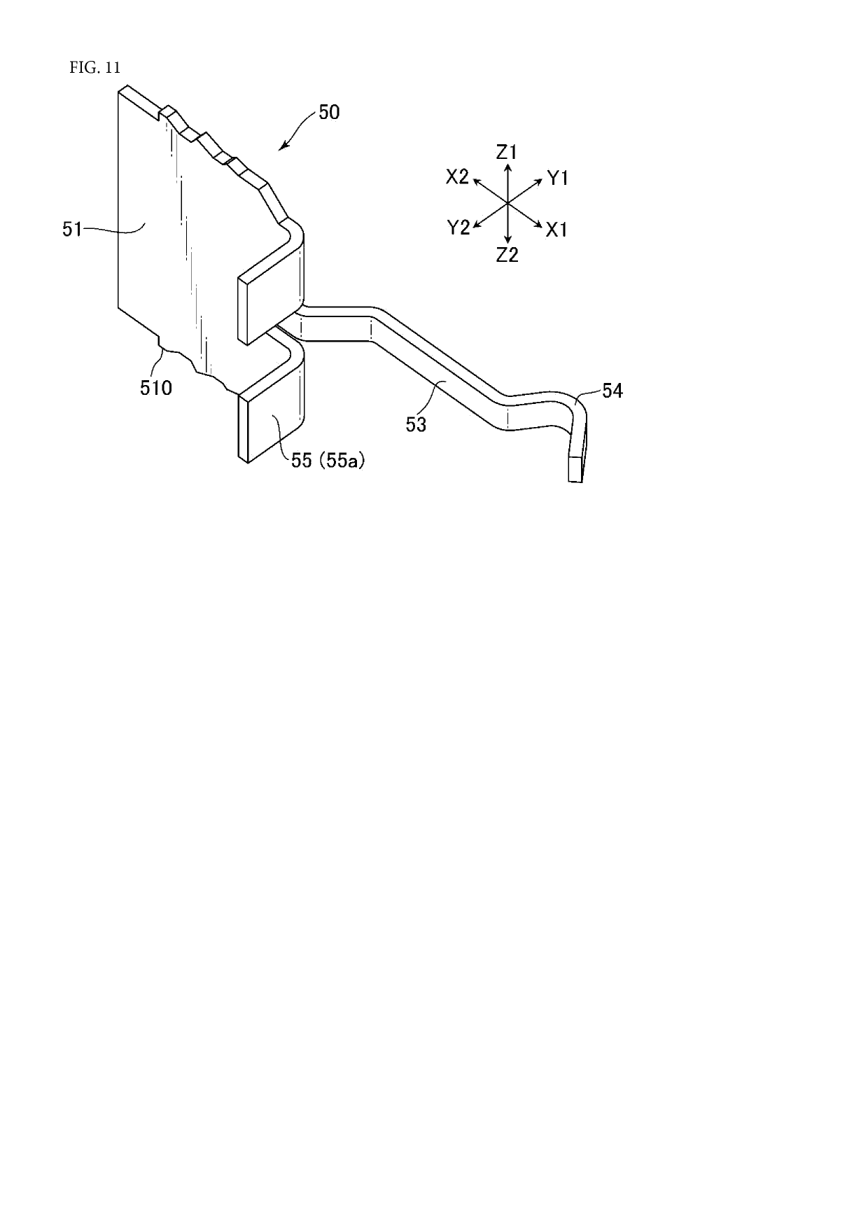

FIG. 11 shows a perspective view of a mounting bracket 50. As in the case of the terminals 20, etc., the mounting brackets 50 are formed in a plate-like configuration by cutting and bending a metal sheet and extend in the forward-backward direction “X” along the same direction as the terminals 20, etc.

The mounting bracket 50 has a base portion 51 of a generally rectangular shape in the middle. Press-fit projections 510 used for securing to the intermediate connector 1 are provided protruding in the up-down direction “Z” substantially in the middle of the base portion 51. At one end of the base portion 51 in the forward-backward direction “X”, there are provided securing portions 55 in which, by bending at right angles so as to stand perpendicularly to the housing 10, in other words, in the width direction “Y”, securing faces 55a are formed in a plane (Y–Z plane) formed by the width direction “Y” and the up-down direction “Z”. Furthermore, a resilient arm portion 53 resiliently deformable in the width direction “Y” extends from one end in the forward-backward direction “X”, and a locking engagement portion 54, which is bent to protrude in the width direction “Y”, is provided at the distal end thereof. In the state shown in FIG. 7, the securing portions 55 are soldered to the pads 77 of the system board 70, and the locking engagement portions 54 lockingly engage the engageable recessed portions 812, 822 provided in the first pad portion 810 and second pad portion 820 of the FPC board 80.

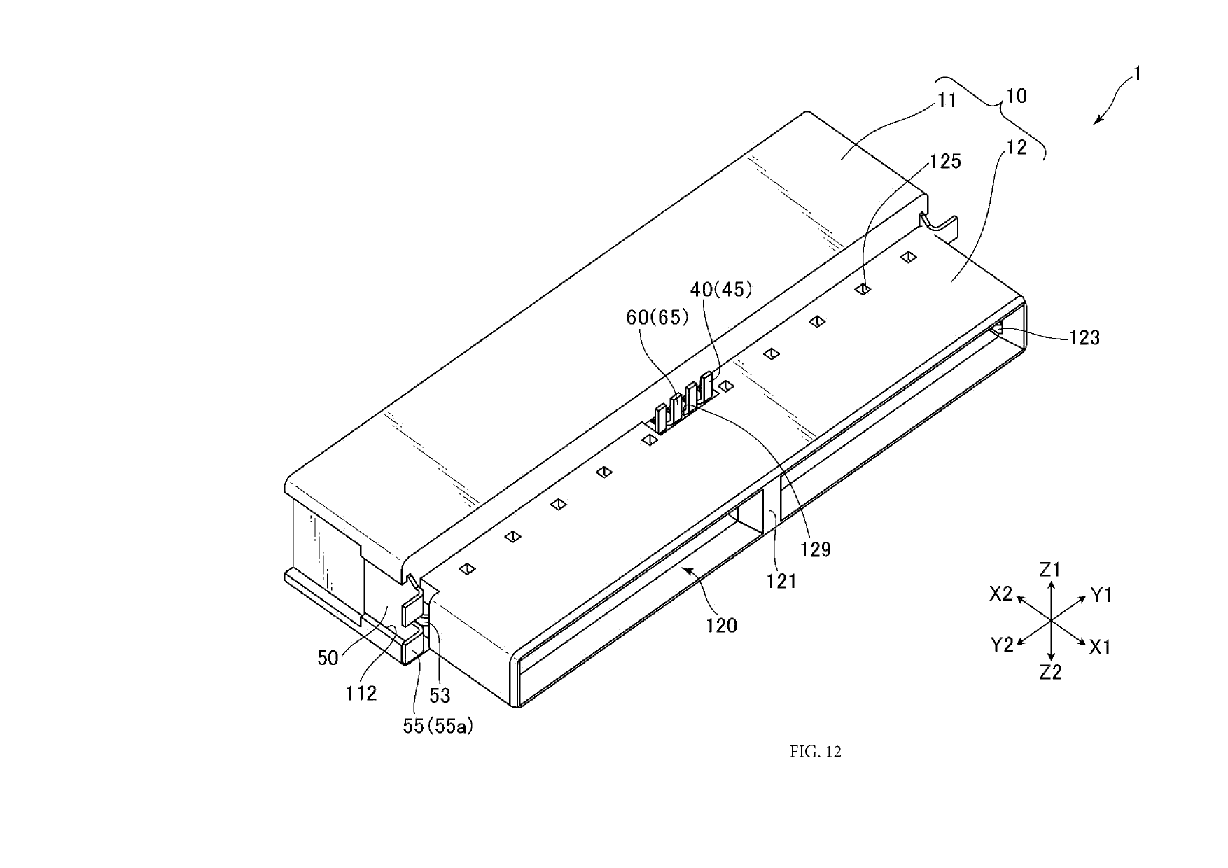

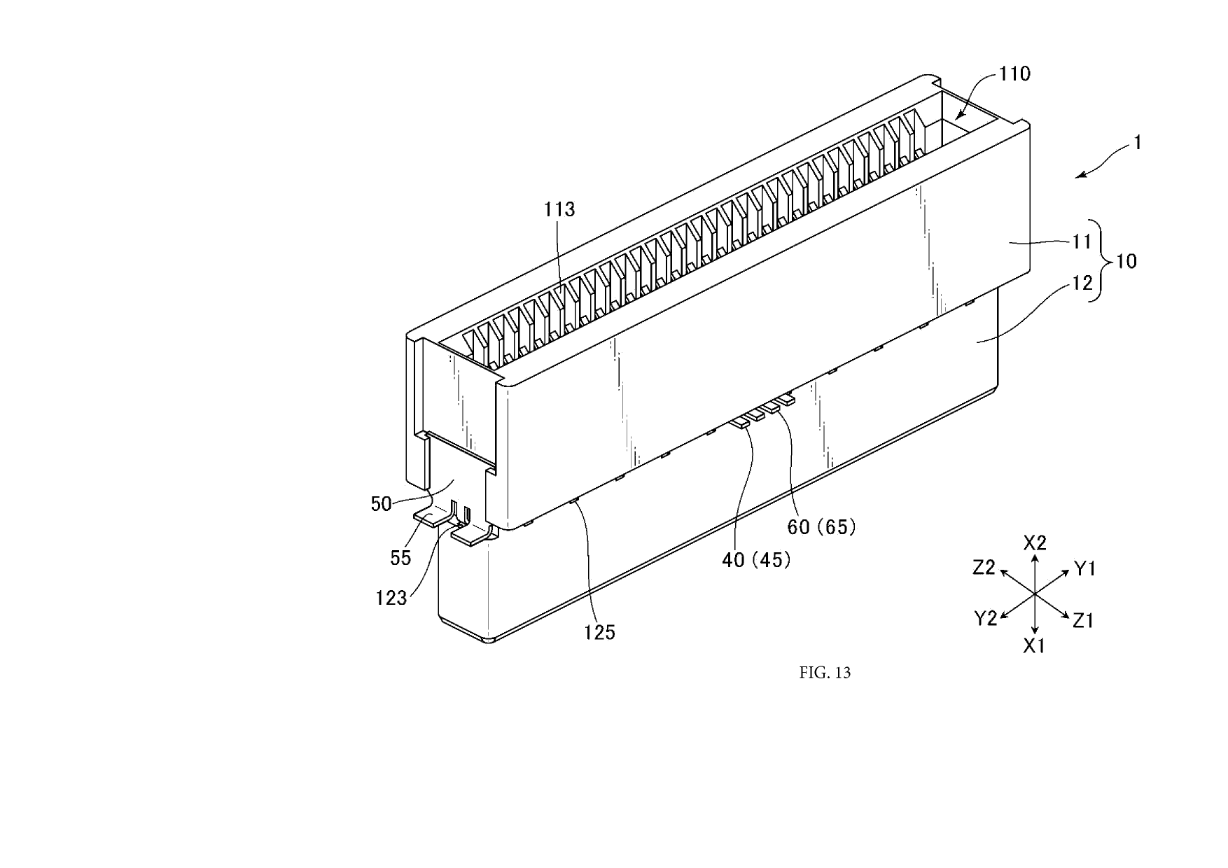

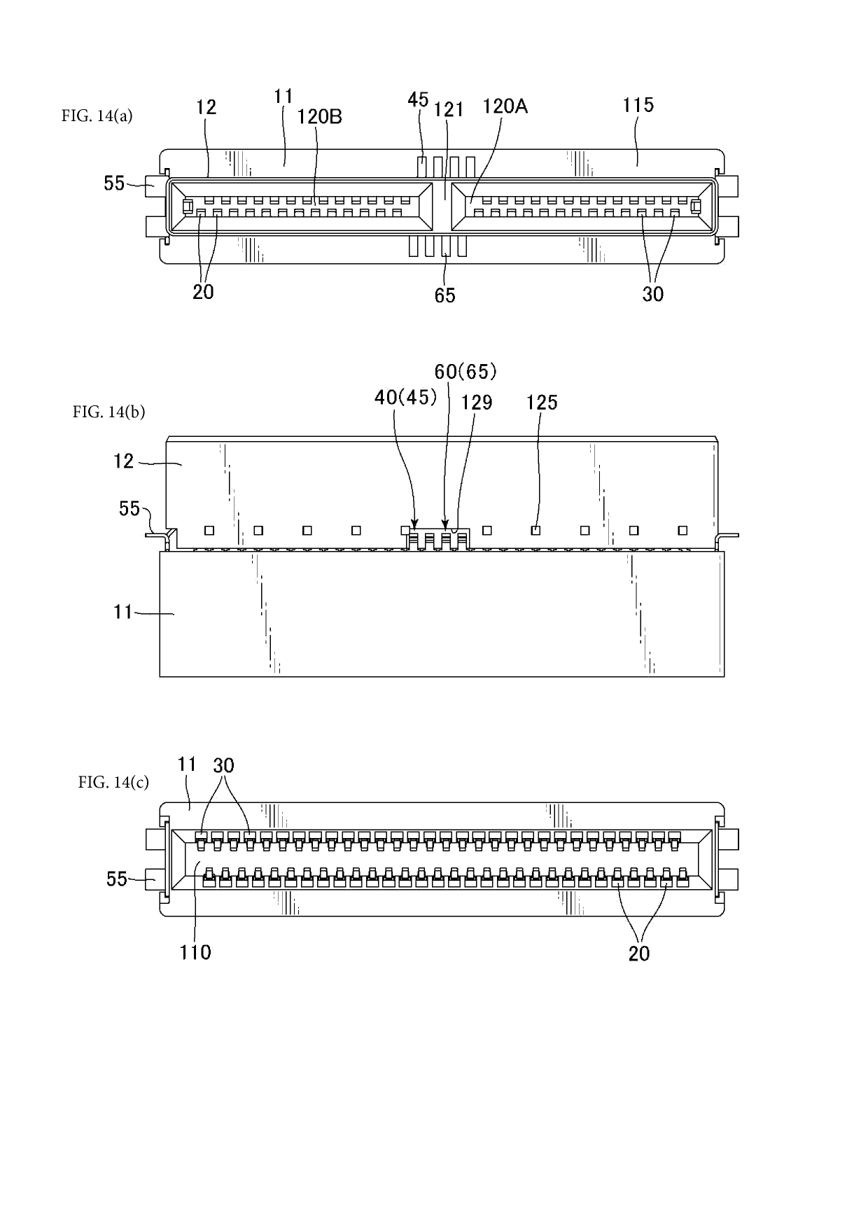

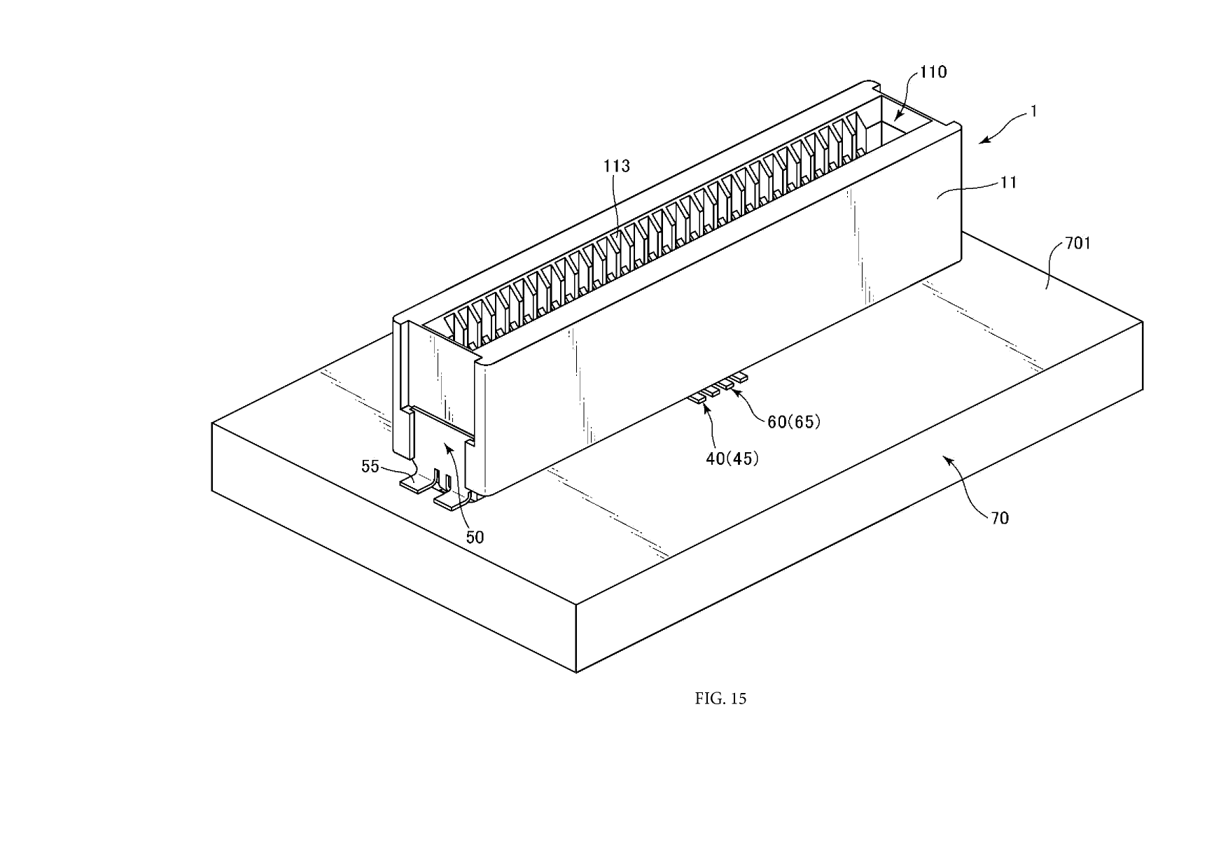

Each of FIGS. 12 through 14(c) shows an individual component view of the intermediate connector. FIG. 12 shows a perspective front face view of the intermediate connector in a horizontally mounted configuration, FIG. 13 shows a perspective rear face view of the intermediate connector in a perpendicularly mounted configuration, and FIG. 14(a) shows a front face view of the intermediate connector, FIG. 14(b) a plan view thereof, and FIG. 14(c) a rear face view thereof. FIG. 15 shows the intermediate connector attached to the system board in a perspective view similar to FIG. 13. It should be noted that, although not apparent from FIG. 15, an FPC board 80 is assumed to be connected to this intermediate connector 1 in addition to the card-edge board 92.

The intermediate connector 1 comprises a plastic housing 10, mounting brackets 50, and multiple terminals 20, etc., installed in the housing 10 in the side-by-side arrangement illustrated in FIG. 7. The housing 10 includes a first housing portion 11 and a second housing portion 12 disposed adjacent each other in the forward-backward direction “X”. Both the first housing portion 11 and the second housing portion 12 are of a generally cuboid shape, with the second housing portion 12 having a smaller cross-section than the first housing portion 11 in the plane (Y–Z plane) formed by the width direction “Y” and the up-down direction “Z”. The second housing portion 12, which has this smaller cross-section, is inserted into a through-hole 71 in the system board 70.

A first insertion space 110, into which a card-edge board 92 is inserted, is provided in the first housing portion 11, and a second insertion space 120, into which an FPC board 80 is inserted, is provided in the second housing portion 12. The card-edge board 92 is inserted into the first insertion space 110 in the direction from the first housing portion 11 toward the second housing portion 12 (X1). Meanwhile, the FPC board 80 is inserted into the second insertion space 120 in the direction from the second housing portion 12 toward the first housing portion 11 (X2). A partition 121 corresponding to the gap 82 provided in the FPC board 80 (FIG. 5, etc.) is formed in the insertion aperture of the second insertion space 120, such that when the FPC board 80 is inserted into the second insertion space 120, receiving the partition 121 in the gap 82 makes it possible to position the FPC board 80 precisely at a predetermined location of the second insertion space 120.

The first housing portion 11 and second housing portion 12 each have multiple terminal grooves 113 (see FIG. 13, FIG. 15, etc.) for installing the terminals 20, etc., in the housing 10. With the help of these terminal grooves 113, etc., the terminals 20, etc., are arranged side by side at predetermined locations equidistantly from one another in a mutually adjacent relationship in the width direction “Y” and, at the same time, along the forward-backward direction “X”. At such time, the signal terminals 20 and ground terminals 30, in their entirety, are installed in the interior of the housing 10. Meanwhile, for the signal-type terminals 40 and power-type terminals 60, only the sides of with the signal-type contacts 44 and power-type contacts 64 are located in the interior of the housing 10, specifically, in the interior of the first housing portion 11, whereas the board connection portions 45, 65 along with their surrounding regions are accommodated in a state exposed outside of the housing 10 in the forward-backward direction “X”, and, more specifically, at the boundary between the first housing portion 11 and second housing portion 12, in particular, in a space 129 provided proximate to the second housing portion 12.

In the second housing portion 12, multiple through-openings 125, which link the base portion 31 of each ground terminal 30 installed in the interior of the housing 10 and the exterior of the housing 10, are provided in the up-down direction “Z” through the housing 10. Each ground terminal 30 can be solder-connected to the common pads 78 of the system board 70 by flowing solder into these through-openings 125. More specifically, all five through-openings 125 (as well as the ground terminals 30) located on one side are electrically connected through the common pads 78 to a set “T”, i.e., “signal-type terminal, power-type terminal, power-type terminal, signal-type terminal,” which is provided in the middle in the width direction “Y”, and, in the same manner, all through-openings 125 (as well as the ground terminals 30) located on the other side are electrically connected through the common pads 79 to a set “T”, thereby making it possible to enhance the functionality of ground connection on each side.

In order to facilitate connection to the common pads 78, 79, all through-openings 125 are provided in the width direction “Y”, in substantially the same position in the forward-backward direction “X” as the connection faces 45a, 65a of the board connection portions 45, 65. In addition, in order to facilitate connection to the system board 70, the securing portions 55 of the mounting brackets 50, in particular, the securing faces 55a proximate to the second housing portion 12 (see FIG. 12, etc.), are also provided in substantially the same position in the forward-backward direction “X” as the through-openings 125 and the connection faces 45a, 65a of the board connection portions 45, 65. As a result, the through-openings 125, the connection faces 45a, 65a of the board connection portions 45, 65, and the securing faces 55a of the securing portions 55 can all be readily soldered to the predetermined pads of the system board 70. It should be noted that, as referred to herein, the term “substantially” implies that the position may be slightly misaligned as long as this does not interfere with soldering.

The mounting brackets 50 are respectively secured to both side faces of the first housing portion 11 in the width direction “Y”. Press-fit grooves 112, into which the base portions 51 of the mounting brackets 50 can be press-fitted, are provided in the respective side faces of the first housing portion 11. The mounting brackets 50 can be secured by sliding the mounting brackets 50 in the press-fit grooves 112 in the forward-backward direction “X”. After sliding the mounting brackets 50 in, the resilient arm portions 53 of the mounting brackets 50 are guided in the “X1” direction through holes provided between the first housing portion 11 and second housing portion 12 into grooves 123 provided in the interior walls of the second insertion space 120 of the second housing portion 12 (see FIGS. 12, 13), and the locking engagement portions 54 provided at the distal ends are precisely positioned to allow locking engagement with the engageable portions 812 of the FPC board 80 inserted into the second housing portion 12 in the “X2” direction.

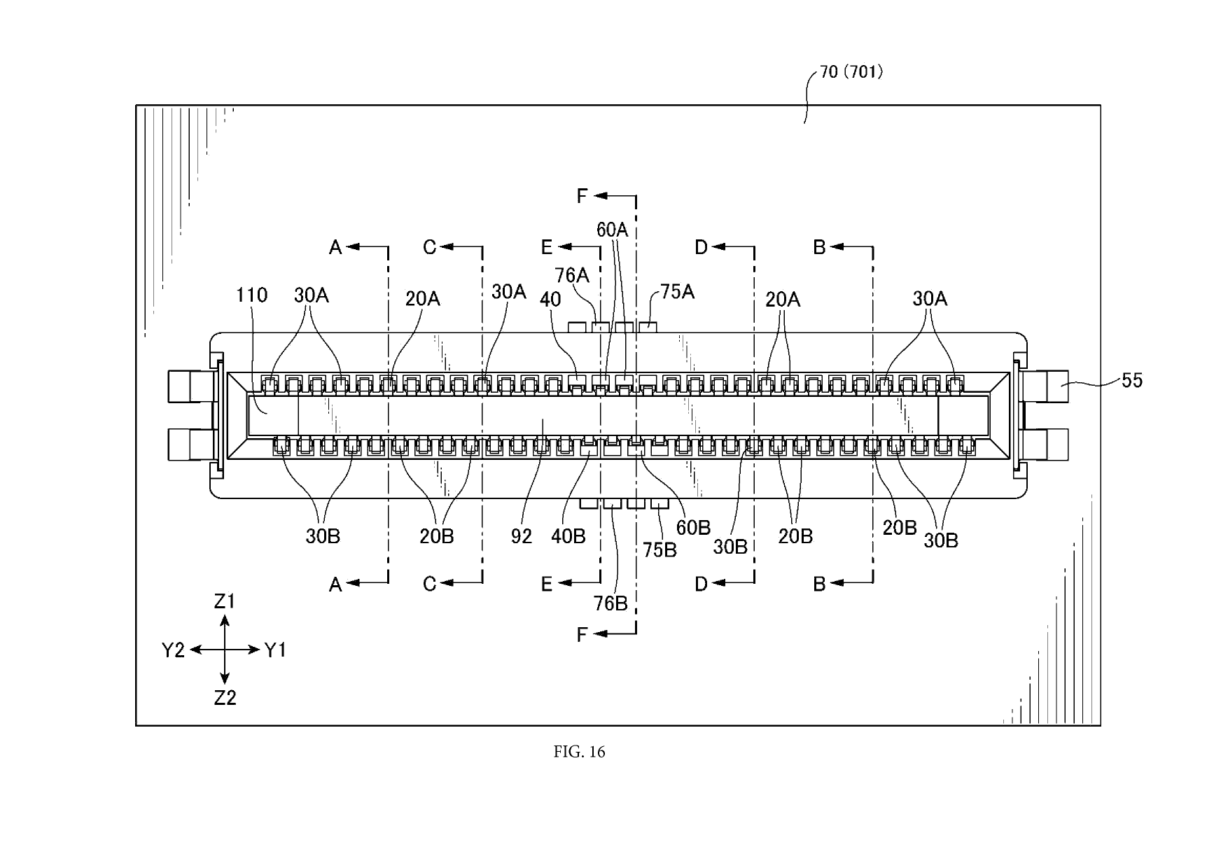

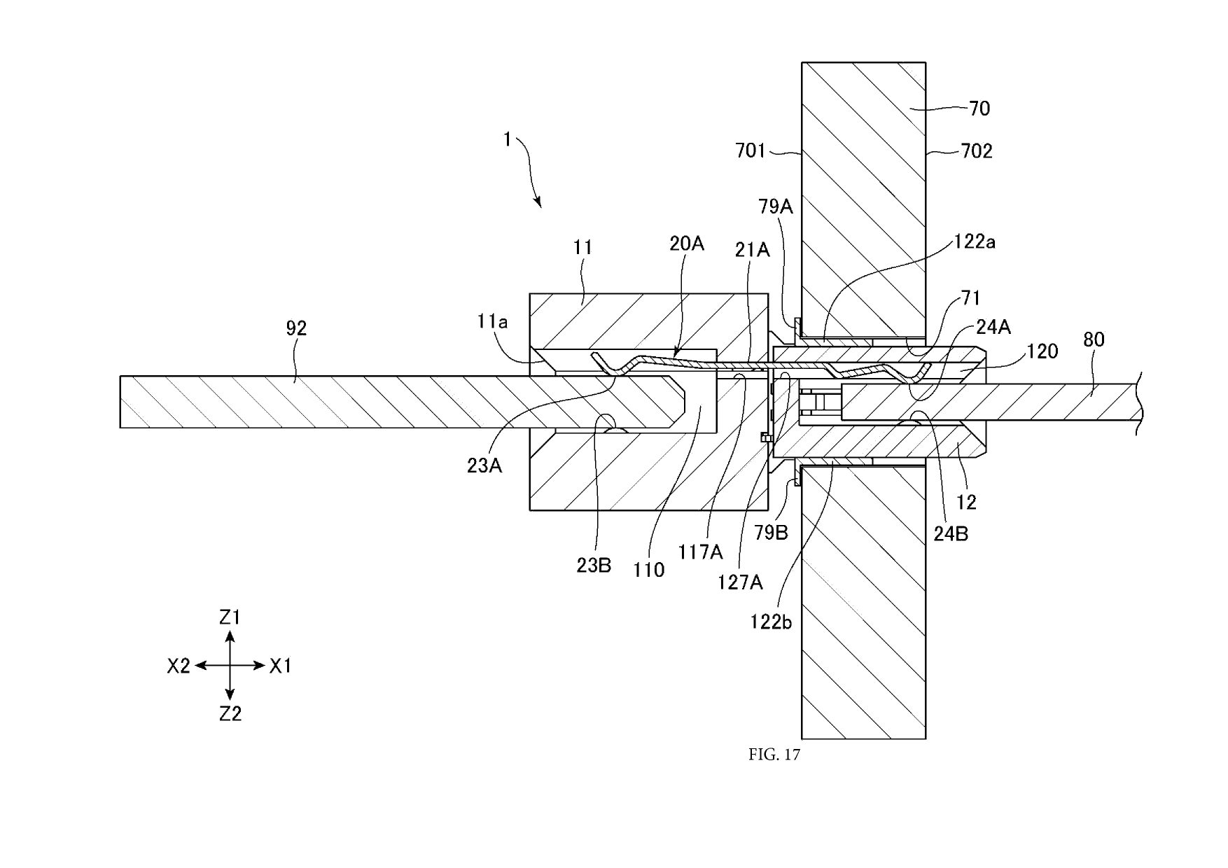

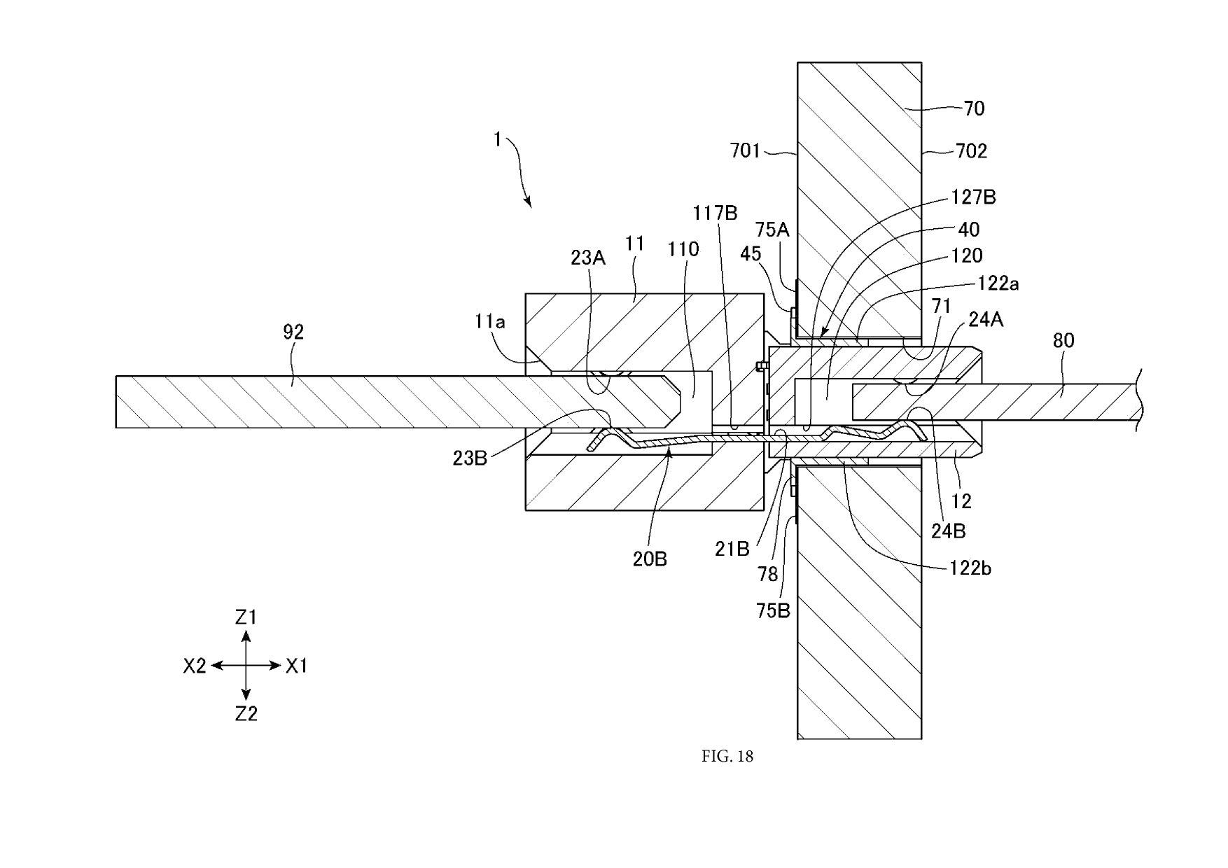

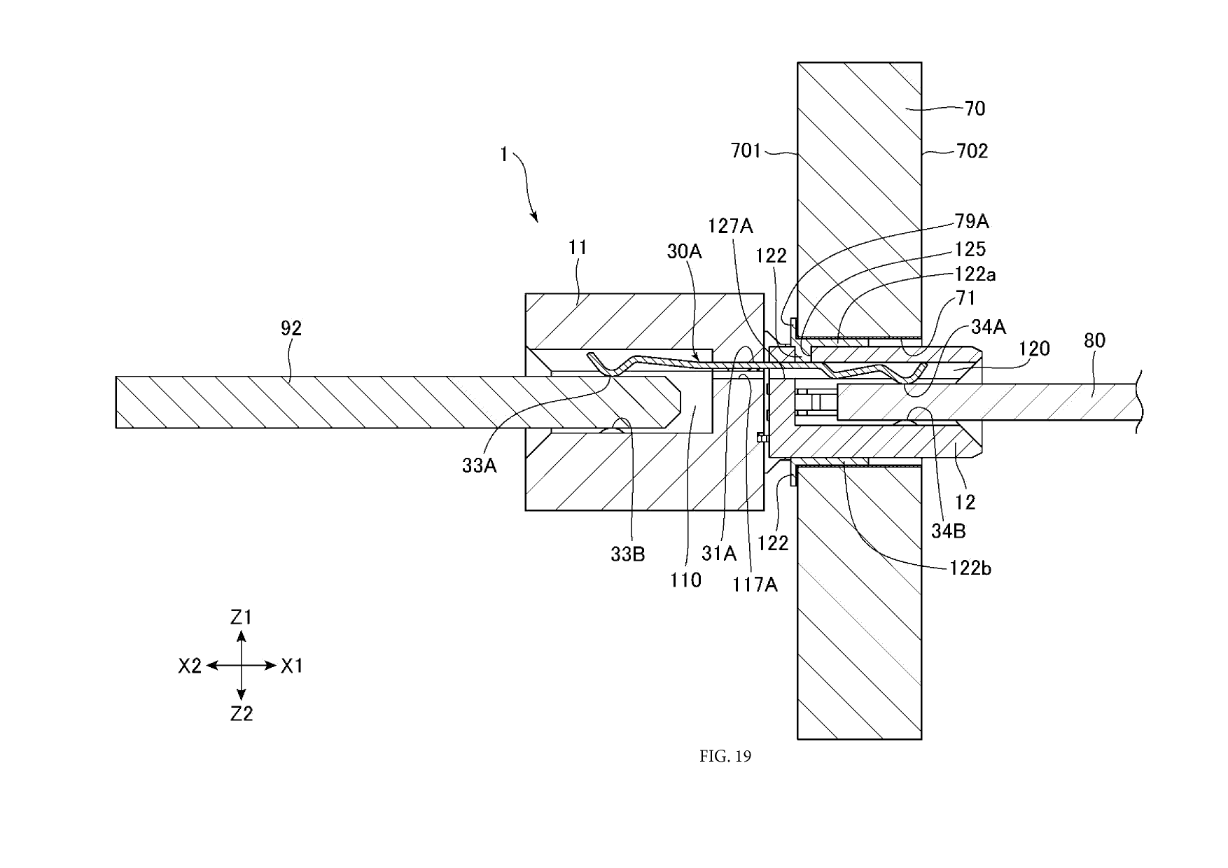

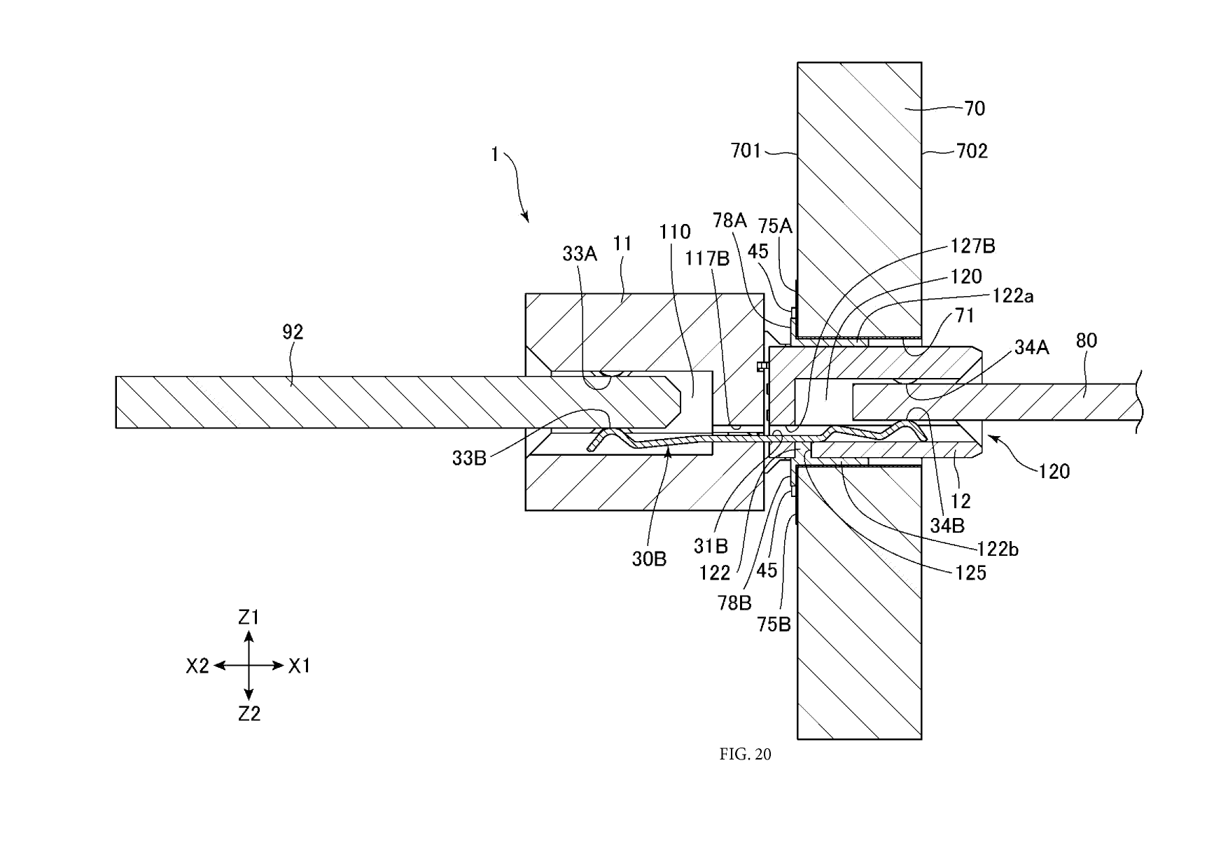

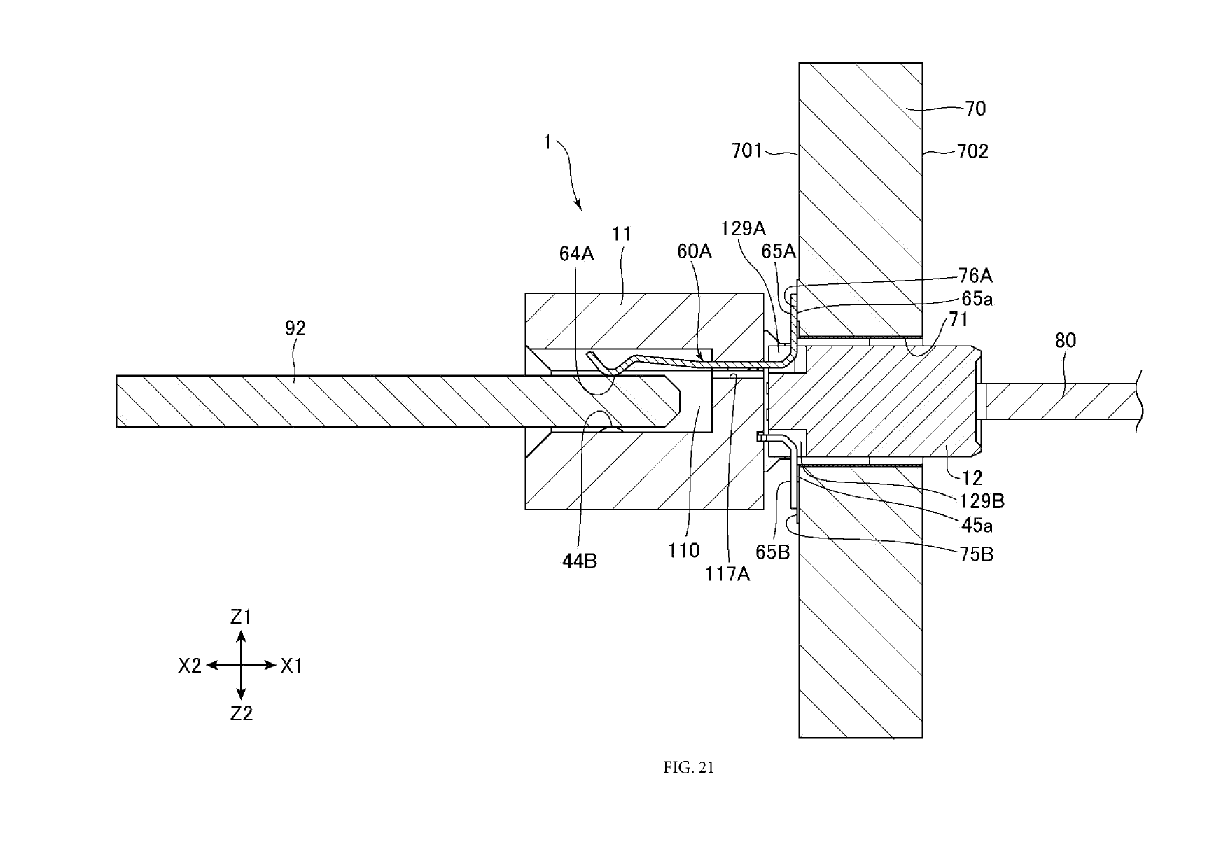

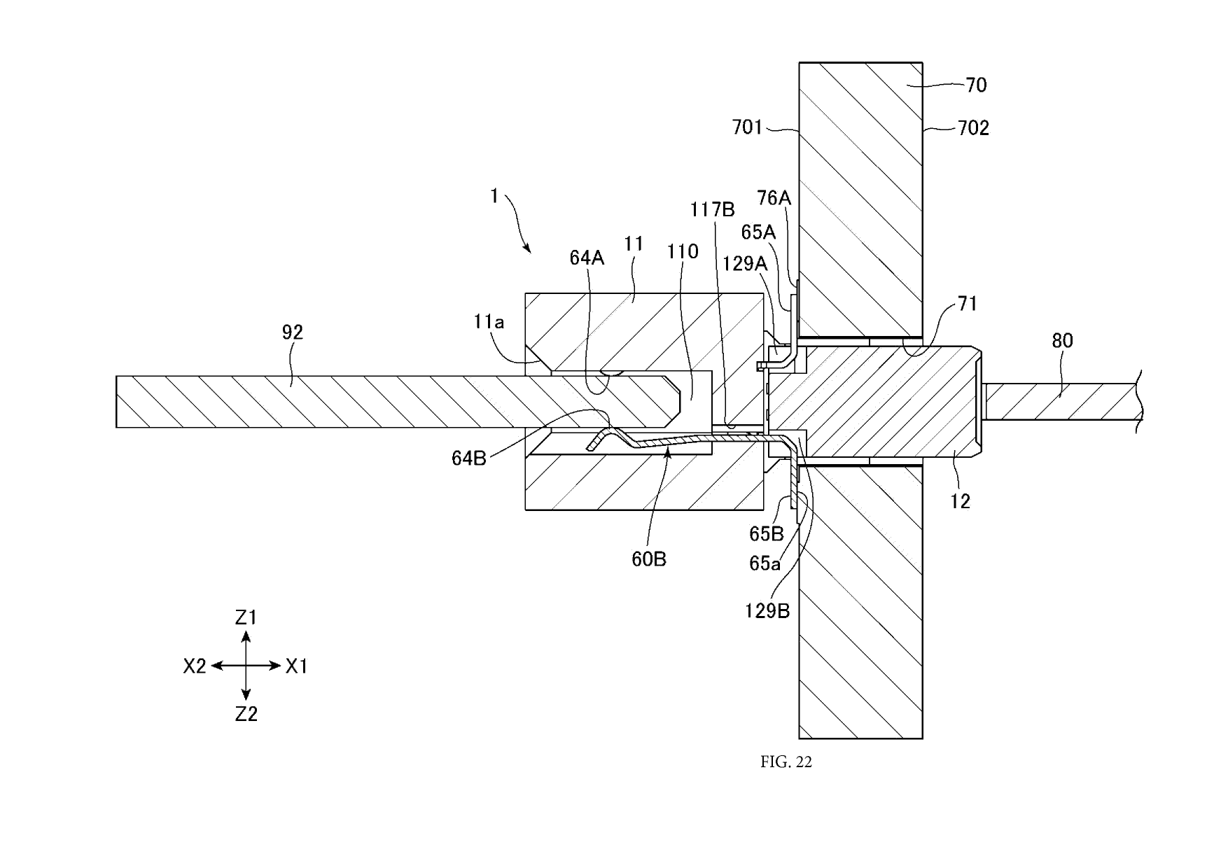

A plan view of FIG. 15 is shown in FIG. 16 and, furthermore, cross-sectional views taken at locations A through F in FIG. 16 are shown in FIGS. 17 to 22. FIGS. 17 and 18 respectively correspond to cross-sections taken along line A–A and line B–B in FIG. 16. More particularly, FIG. 17 shows a cross-section taken through a signal terminal 20A included in the first terminal group A, and FIG. 18 shows a cross-section taken through a signal terminal 20B included in the second terminal group B. In addition, FIGS. 19 and 20 respectively correspond to cross-sections taken along line C–C and line D–D in FIG. 16. More particularly, FIG. 19 shows a cross-section taken through a ground terminal 30A included in the first terminal group A, and FIG. 20 shows a cross-section taken through a ground terminal 30B included in the second terminal group B. Furthermore, FIGS. 21 and 22 respectively correspond to cross-sections taken along line E–E and line F–F in FIG. 16. More particularly, FIG. 21 shows a cross-section taken through a board connection terminal, in particular, a power-type terminal 60A included in the first terminal group A, and FIG. 22 shows a cross-section taken through a board connection terminal, in particular, a power-type terminal 60B included in the second terminal group B. It should be noted that the signal-type terminals 40A, 40B may be considered identical to the power-type terminals 60A, 60B.

As clearly shown in FIGS. 19 to 22, when a portion of the second housing portion 12 is inserted into the through-hole 71 in the direction of insertion “X1”, the system board 70, namely, its board face 701 provided with pads 75 to 79, which is located in front in the direction of insertion “X1”, is brought in juxtaposition to the connection faces 45a, 65a of the board connection terminals 40, 60 and the securing faces 55a of the mounting brackets 50, which are disposed in substantially the same position as the connection faces 45a, 65a in the forward-backward direction “X”.

As clearly shown in FIGS. 17 and 18, at the cross-sectional locations of the signal terminals 20, the intermediate connector 1 is secured to the common pads 78, 79 of the system board 70 using solder 122a, 122b that enters the gap between the through-hole 71 and the exterior side faces of the second housing portion 12 in the up-down direction “Z”. The signal terminals 20 are installed so as to span both the first housing portion 11 and the second housing portion 12 through through-passages 117 and through-passages 127, which communicate the second insertion space 120 with the first insertion space 110 and are provided respectively in the first housing portion 11 and second housing portion 12. The first signal contacts 23 of the signal terminals 20 are positioned in the first insertion space 110, and the second signal contacts 24 are positioned in the second insertion space 120, respectively, such that one end of the card-edge board 92 can be resiliently sandwiched in the up-down direction between the first signal contacts 23A of the signal terminals 20A, etc., and the first signal contacts 23B of the signal terminals 20B, etc., and, in the same manner, one end of the FPC board 80 can be resiliently sandwiched in the up-down direction between the second signal contacts 24A of the signal terminals 20A, etc., and the second signal contacts 24B of the signal terminals 20B, etc.

As best shown in FIGS. 19 and 20, at the cross-sectional locations of the ground terminals 30, the intermediate connector 1 is secured to the common pads 78, 79 of the system board 70 using solder 122a, 122b that enters the gap between the through-hole 71 and the exterior side faces of the second housing portion 12 in the up-down direction “Z”. Furthermore, the base portion 31 of each ground terminal 30 installed in the second housing portion 12 is solder-connected to a common pad 79 on the system board 70 through the medium of solder flowing in through the through-openings 125, as a result of which ground connection is enhanced. As in the case of the signal terminals 20, the ground terminals 30 are installed so as to span both the first housing portion 11 and the second housing portion 12 through through-passages 117 and through-passages 127, which place the second insertion space 120 and the first insertion space 110 in communication with each other and are provided respectively in the first housing portion 11 and second housing portion 12. The first ground contacts 33 of the ground terminals 30 are positioned in the first insertion space 110, and the second ground contacts 34 are positioned in the second insertion space 120, such that one end of the card-edge board 92 can be resiliently sandwiched in the up-down direction between the first ground contacts 33A of the ground terminals 30A, etc., and the first ground contacts 33B of the ground terminals 30B, etc., and, in the same manner, one end of the FPC board 80 can be resiliently sandwiched in the up-down direction between the second ground contacts 34A of the ground terminals 30A, etc., and the second ground contacts 34B of the ground terminals 30B, etc.

As clearly shown in FIGS. 21 to 22, when a portion of the second housing portion 12 is inserted into the through-hole 71 in the direction of insertion “X1”, the system board 70, namely, the board face 701 provided with pads 75 to 79, which is located in front in the direction of insertion “X1”, is brought in juxtaposition to the connection faces 45a, 65a of the board connection terminals 40, 60, and, furthermore, to the securing faces 55a of the mounting brackets 50, which are disposed (see FIGS. 12 to 15, etc.) in substantially the same position as the connection faces 45a, 65a in the forward-backward direction “X”. In addition, at the cross-sectional locations of the board connection terminals shown in these figures, the power-type terminals 60 (and signal-type terminals 40) are installed so as to span both the first housing portion 11 and the second housing portion 12 through the through-passages 117 provided in the first housing portion 11 and the space 129 formed in the second housing portion 12. At such time, the electrical contacts 64 (and signal-type contacts 44) positioned in the first insertion space 110, more specifically, the power-type contacts 64A (and signal-type contacts 44A), etc., and power-type contacts 64B (and signal-type contacts 44B), etc., form an insertion aperture capable of resiliently sandwiching one end of the card-edge board 92 in the up-down direction. In addition, the board connection portions 65 (and board connection portions 45) are positioned in the second housing portion 12. Meanwhile, the board connection portions 65A (and board connection portions 45A) and board connection portions 65B (and board connection portions 45B) positioned proximate to the second housing portion 12 are solder-connected to the pads 76, 75 provided on the board face 701 of the system board 70 via the connection faces 65a, 45a. Furthermore, while not apparent from the drawings, the securing faces 55a provided in the securing portions 55 of the mounting brackets 50 are at the same time secured, via the securing faces 55a, to the pads 77 provided on the board face 701 of the system board 70.

Further aspects, features and effects of the present invention will become readily apparent from the following detailed description, which merely sets forth numerous specific embodiments and examples, including the best mode intended for carrying out the present invention. In addition, the present invention is capable of other and different embodiments, and its numerous details are capable of modifications in various obvious respects, all without departing from the spirit and scope of the present invention. Therefore, the drawings and descriptions are merely illustrative, and the invention is not limited thereto.

### Description of the Reference Numerals

1 Intermediate connector

2 System

5 Connector

10 Housing

11 First housing portion

12 Second housing portion

20 Signal terminal

23 First signal contact

24 Second signal contact

30 Ground terminal

33 First ground contact

34 Second ground contact

40 Board connection terminal

44 Electrical contact (signal-type contact)

45 Board connection portion

50 Mounting bracket

55 Securing portion

60 Board connection terminal (power-type terminal)

64 Electrical contact (power-type contact)

65 Board connection portion

70 System board

71 Through-hole

73 Vent

75 Interior space

80 FPC board (second board)

90 Module (optical transceiver)

92 Card-edge board (first board)

110 First insertion space

117 Through-passage

120 Second insertion space

125 Through-opening

129 Space

1. A system provided with an intermediate connector, the intermediate connector comprising:
a housing having a first housing portion and a second housing portion, in which a first insertion space, into which a first board is inserted, is provided in the first housing portion, and a second insertion space, into which a second board is inserted, is provided in the second housing portion; and
a plurality of terminals installed so as to span both the first housing portion and the second housing portion;
the system being attachable such that at least a portion of the second housing portion is inserted into a through-hole provided in a system board that forms part of the system.

2. The system according to claim 1, wherein the system further comprises a casing that includes the system board as a component part and accommodates a portion of the second board.

3. The system according to claim 2 wherein, in the interior of the casing, the second board has extension sections that extend toward components other than the system board.

4. The system according to claim 3, wherein a gap is provided between every two extension sections.

5. The system according to claim 2 wherein, in the interior of the casing, the second board is connectable to component parts provided in components other than the system board.

6. The system according to claim 2, wherein vents communicating with the interior of the casing are provided in the system board.

7. The system according to claim 6, wherein the vents are disposed between every two through-holes.

8. The system according to claim 1, wherein the first board is inserted into the first insertion space in the direction from the first housing portion toward the second housing portion, and
the second board is inserted into the second insertion space in the direction from the second housing portion toward the first housing portion.

9. The system according to claim 1, wherein when at least a portion of the second housing portion is inserted into the through-hole, the board face of the system board, to which several terminals among the plurality of terminals provided in the intermediate connector are attached, forms a plane intersecting the direction of insertion in which at least a portion of the second housing portion is inserted into the through-hole.

10. The system according to claim 1, wherein board connection portions that can be connected to the system board are provided proximate to the second housing portion in several terminals among the plurality of terminals.

11. The system according to claim 10, wherein the board connection portions have connection faces that can be connected to the board face of the system board when at least a portion of the second housing portion is inserted into the through-hole in the direction from the first housing portion toward the second housing portion.

12. The system according to claim 11, wherein the connection faces can be connected to the board face of the system board located in front in the direction of insertion when at least a portion of the second housing portion is inserted into the through-hole in the direction from the first housing portion toward the second housing portion.

13. The system according to claim 11, wherein the connection faces are provided in a plane intersecting the direction of insertion in which at least a portion of the second housing portion is inserted into the through-hole.

14. The system according to claim 11, wherein mounting brackets are furthermore installed in the housing, and
the mounting brackets comprise securing portions having securing faces that can be secured to the board face of the system board when at least a portion of the second housing portion is inserted into the through-hole.

15. The system according to claim 14, wherein the securing faces are provided in a plane intersecting the direction of insertion in which at least a portion of the second housing portion is inserted into the through-hole, and, in the direction along the direction of insertion, are positioned in substantially the same position as the connection faces.

16. The system according to claim 1, wherein the first board is a component part of the module.

17. The system of claim 1, wherein an FPC board serves as the second board.
